(19) United States
(12) Patent Application Publication
(10) Pub. No.: US 2021/0110634 A1
(43) Pub. Date: Apr. 15, 2021

(54) GAMING SYSTEM AND METHOD USING MULTIPLE INTERACTIVE DISPLAYS

(71) Applicant: ADP GAUSELMANN GMBH, Espelkamp (DE)

(72) Inventors: Charles Hiten, Lighthouse, FL (US); Michael Charles Halvorson, Las Vegas, NV (US)

(21) Appl. No.: 16/600,484

(22) Filed: Oct. 12, 2019

(51) Int. Cl. G07F 17/32

(52) U.S. Cl. CPC G07F 17/3213; G07F 17/3251; G07F 17/3262

(57) ABSTRACT

Systems, methods, and computer-readable mediums for a gaming system are disclosed. Operations performed by the gaming system include determining first symbols for first symbol display areas and determining second symbols for second symbol display areas. The operations also include displaying the first symbols in the first symbol display areas and the second symbols in the second symbol display areas. The operations also include transposing one or more of the second symbols from the second symbol display areas to the first symbol display areas, wherein the transposing increases an amount of the one or more second symbols. The operations also include determining that the first symbols and the one or more second symbols displayed in the first symbol display areas include a winning symbol combination.

### FIELD

The present disclosure relates to gaming systems.

### BACKGROUND

Gaming systems accept wagers from players in exchange for opportunities to win awards or prizes. Current gaming systems combine various specialized computing technologies to provide systems adapted to gain the attention of players and to keep them engaged with the gaming systems. To retain players' interest, gaming systems that offer new and unconventional functionality are needed.

### SUMMARY

The present disclosure is directed to systems and processes for gaming. In some implementations, a gaming system disclosed herein provides a game that randomly determines symbols and displays such symbols to players using a display device. In some implementations, the gaming system evaluates the displayed symbols to determine whether they correspond to predetermined awards.

A gaming system in accordance with aspects of the present disclosure provides a first game screen and a second game screen that interact. The interactions can be affected by linking display areas linking the first game screen and the second game screen. In some implementations, the first and second game screens are separately displayed on first and second display devices. In some implementations, the linking display areas can be located in the first game screen, the second game screen, or split between the first and second game screens. In some implementations, the first game screen, the second game screen, and the linking display area may be co-located on one or more display devices. In some implementations, the interactions between the first and second game screens involve transposing symbols between the first game screen and the second game screen, wherein the linking display areas may increase an amount of the transposed symbols. In some implementations, increasing the amount can include increasing a value of a transposed symbol. In some implementations, increasing the amount can include increasing a quantity of the transposed symbol.

In some implementations, the linking display areas can function as portals through which symbols transposing or moving between the first game screen and the second game screen pass. The linking display areas can display indicators (e.g., modifiers) that modify the amounts of the transposed symbols. In some implementations, the gaming system randomly determines the indicators displayed by the linking display areas. In other implementations, the gaming system determines the indicators by accumulating counts of predetermined symbols displayed in the second game screen over several games of a gaming session. It should be appreciated that the gaming system may determine the indicators in any suitable manner.

In some implementations, the first and second game screens are comprised of vertically-stacked symbol display areas forming columns that can represent reels of a slot machine. The first and second game screens can be stacked with their respective reels vertically aligned with one another. In some implementations, symbol display areas of the reels in the first game screen may positionally correspond with symbol display areas of the second game screen.

In some implementations, the linking display areas include a plurality of display areas that correspond to the respective reels of the first and second game screens. For example, the linking display areas can be displayed using a third game screen vertically stacked between the first game screen and the second game screen. In such an arrangement, the corresponding reels of the first display screen, the second display screen, and a display area of the third display screen may be vertically aligned.

In accordance with aspects of the present disclosure, the first game screen and the second game screen display randomly-generated symbols for a game. In some implementations, the first game screen displays first symbols selected from a first symbol set and the second game screen displays second symbols selected from a second symbol set. It should be appreciated that the first symbol set and the second symbol set may have no symbols in common, some symbols in common, or all symbols in common. In some implementations, when the first game screen and the second game screen interact, the second symbols may modify or replace one or more of the first symbols. In some implementations, the second symbol set includes special symbols, such as WILD symbols, multiplier symbols, trigger symbols, scatter symbols or collection symbols. In some implementations, one or more of the second symbols can be transposed from the second game screen to the first game screen and create new winning symbol combinations or bonus trigger combinations when evaluated in combination with the first symbols displayed in the first game screen. For example, in response to a trigger event, the gaming system may transpose a WILD symbol from a second symbol display area to a first symbol display area in the first game screen. The WILD symbol may form a new winning symbol combination with the symbols previously displayed by the first game screen.

In some implementations, the gaming system may transpose or move second symbols from the second game screen to the first game screen by moving the second symbols via the linking display area. As can be appreciated, the linking display area creates a portal to transpose or move second symbols from the second game screen to the first game screen (e.g., the second symbols may fall into, or otherwise are drawn into the linking display areas before disappearing and then reappearing in the first game screen). In some implementations, the gaming system may modify the second symbols during symbol transposition. For example, the gaming system may modify the amount of the transposed second symbols via a numeric indicator associated with the linking display area. For example, the gaming system may associate an indicator of “3” with a linking display area. In such an implementation, one or more winning symbol combinations formed on the first game screen including the second symbol transposed via the “3” linking display area may be increased by a 3× multiplier value. In some implementations, the gaming system may modify an amount of the second symbol by altering the quantity of second display symbols. For example, the gaming system may associate a value of “3” with the linking display area. In such an implementation, a second symbol transposed to the first game screen via the “3” linking display area results in three instances of the second symbol being copied to the first game screen. In such implementations, the instances of the second symbol may be displayed in the vertically-aligned reel of the first game screen corresponding to the reel of second game screen that displayed the transposed second symbol. In other such implementations, the gaming system may randomly display the three instances of the second symbol in the first game screen on different reels. For example, the gaming system may cause one of the second symbols to fall (e.g., rain down) from the second symbol display screen via the linking display area and disappear and cause three instances of the second symbol appear and fall into three randomly-selected symbol display areas of the first game screen.

Further, in some implementations the gaming system can transpose symbols from the first game screen to the second game screen in a same or similar manner to the transposition of symbols displayed by the second game screen to the first game screen. For example, the gaming system may transpose a predetermined type of first symbol (e.g., a WILD symbol) in a symbol display area of the first game screen to a symbol display area in the second game screen in response to a triggering event. In some implementations, the transposed first symbol can remain displayed (e.g., locked) in the second game screen over one or more plays of the game or until another trigger event in the game causes the gaming system to transpose the first symbol from the second game screen back onto the first game screen. In some implementations, the gaming system may be triggered to transpose the first symbol from the first game screen to the second game screen as a consolation opportunity. For example, the gaming system may store the first symbol in the second game screen in response to the first symbol failing to combine in a winning symbol combination during a play of the game. For example, if a WILD symbol is randomly-generated in the game but does not form part of a winning combination, the gaming system may transpose the WILD symbol to the second game screen. In some implementations, the WILD symbol may transpose through the linking display area of the third game screen, which can modify the WILD symbol in a same or similar manner to that previously described. Additionally, in some implementations, the gaming system may offer a player the option to transpose and store the first symbol to the secondary game screen for a fee or an additional wager amount.

Still further, in accordance with aspects of the present disclosure, the symbols displayed by the first game screen and the symbols displayed by the second game screen can include special symbols that can trigger or initiate a bonus game. In some implementations, where the first game screen obtained less than a threshold quantity of special symbols to trigger a bonus game, the gaming system may cause special symbols displayed in the second game screen to be moved or transposed to the first game screen. In some implementations, the special symbols moved or transposed to the first game screen can be used in combination with the original special symbols in the first game screen to trigger the bonus game. In some implementations, the special symbols can be collection symbols (which may also be referred to as storage symbols or persistent symbols) that accumulate over several plays of a game. For example, the special symbols generated in the first game screen can persist in their respective symbol display areas from play-to-play during a gaming session. And, in some implementations, representations or counts of special symbols generated in the second game screen persist in their respective linking display areas from play-to-play during a gaming session. In response to a trigger event, the gaming system may display additional special symbols in the first game screen based on the quantities of special symbols accumulated in one or more of the linking display areas. Further, based on the combination and quantity of the special symbols displayed in the first game screen, the gaming system may initiate an additional game, or game feature. For example, after a triggering event in a game causes the gaming system to display additional special symbols transposed from the second game screen via the linking display areas, the gaming system may initiate a bonus game or a bonus feature in the event the quantity of special symbols displayed in the first game screen is greater than or equal to a predetermined threshold value.

As described above and set forth in greater detail below, gaming systems in accordance with aspects of the present disclosure provide a specialized computing device integrating non-generic hardware and software that improve upon the existing technology of human-computer interfaces by providing unconventional functions, operations, and symbol sets for generating interactive displays and outputs. The features of the gaming system provide a practical implementation that improves the operation of the gaming systems for their specialized purpose of providing entertainment by increasing the range of gameplay provided by individual systems. Further, the feature reduces player disappointment with game outcomes by enhancing player enjoyment and by increasing player engagement. Further, the features improve the operation of the gaming system by integrating the functionality of multiple game screens and game display devices.

### BRIEF DESCRIPTION OF THE DRAWINGS

FIG. 1 shows a perspective view illustrating an example gaming system in accordance with aspects of the present disclosure.

FIG. 2 shows a functional block diagram illustrating a game controller and gaming system in accordance with aspects of the present disclosure.

FIG. 3 illustrates an example of an environment for implementing systems and processes in accordance with aspects of the present disclosure.

FIGS. 4A, 4B, 4C, and 4D show a process flow diagram illustrating an example method of operating the gaming system in accordance with aspects of the present disclosure.

FIGS. 5A, 5B, 5C, 5D, and 5E illustrate game screens displayed by a gaming system in accordance with aspects of the present disclosure.

FIGS. 6A and 6B illustrate game screens displayed by a gaming system in accordance with aspects of the present disclosure.

FIGS. 7A and 7B illustrate game screens displayed by a gaming system in accordance with aspects of the present disclosure.

FIGS. 8A, 8B, and 8C illustrate game screens displayed by a gaming system in accordance with aspects of the present disclosure.

FIGS. 9A, 9B, and 9C show a process flow diagram illustrating an example method of operating the gaming system in accordance with aspects of the present disclosure.

FIGS. 10A, 10B, 10C, 10D, 10E, and 10F illustrate game screens displayed by a gaming system in accordance with aspects of the present disclosure.

### DETAILED DESCRIPTION

The present disclosure provides systems and processes for gaming and amusement devices. As detailed above, a gaming system consistent with the present disclosure can provides multiple game screens having corresponding symbol display areas that can interact. In accordance with aspects of the present disclosure, a gaming system provides a first game screen and a second game screen that interact depending on symbols displayed by the individual game screens. Additionally, in some implementations, interactions between the first and second game screens are modified by symbols displayed by a third game screen.

Implementations consistent with the present disclosure provide systems, methods, and computer-readable mediums configured to perform particular operations by virtue of program instructions executed by a processor. The operations include establishing a credit balance based at least in part on a monetary value received by a value acceptor. The operations also include receiving, via an input device, a wager. The operations also include initiating a play of a game based on the wager. The operations also include determining, using a random number generator, first symbols for first symbol display areas. The operations also include determining, using the random number generator, second symbols for second symbol display areas. The operations also include displaying, using one or more display devices, the first symbols in the first symbol display areas. The operations also include displaying, using the one or more display devices, the second symbols in the second symbol display areas. The operations also include transposing one or more second symbols from the second symbol display areas to the first symbol display areas, wherein the transposing increases an amount of the one or more second symbols. The operations also include determining that the first symbols and the one or more second symbols displayed in the first symbol display areas includes a winning symbol combination. The operations also include determining awards corresponding to the winning symbol combination. The operations also include displaying, using the one or more display devices, the one or more awards, wherein the credit balance is increased by the awards award. The operations also include issuing, using the value dispenser, a value based on the credit balance in response to a cash out request.

### Gaming System Platform

The features and advantages of the systems and methods described herein may be provided to a player via a gaming system that includes various structures and components for allowing player interaction with the gaming system. While some examples of gaming systems are described in detail herein, it is understood that the features, objects, and advantages of such gaming systems may be implemented in one or more alternative implementations consistent with the present disclosure.

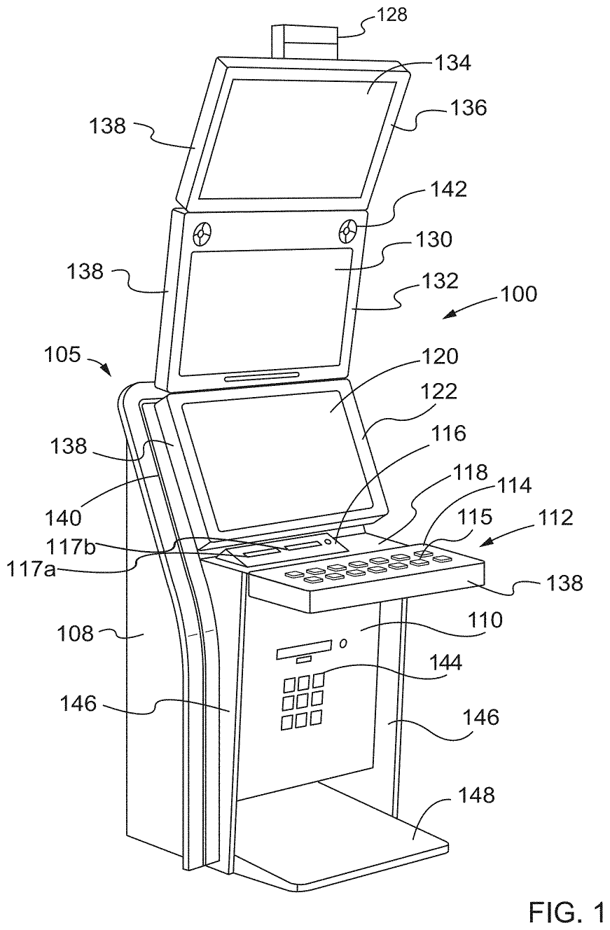

FIG. 1 shows a perspective view illustrating an example of gaming system 100 in accordance with aspects of the present disclosure. The gaming system 100 may be referred to as a slot machine and, as illustrated, includes a cabinet 105 (e.g., a housing) constructed so that a player can operate and play the gaming system 100 while standing or sitting. The cabinet 105 can include a pair of cabinet side panels 108 (one of which is visible in the perspective view of FIG. 1 and another that is partially visible in FIG. 1), a front panel 110, and a rear panel (not shown). Additionally, a base panel (not shown) and a top panel surface (not shown) may support a first game display device 120 and the player interaction area 112. The cabinet panels 108, 110 (as well as the base panel and the top panel surface) may be interconnected to form the cabinet 105, which encloses and houses components of the gaming system 100. The cabinet 105 may function to securely protect a local game controller and technology components, and to provide support for game display(s) and player input and output systems of the gaming system 100, such as described herein below.

While the example cabinet 105 is depicted as having a particular shape, structure, and organization, it should be appreciated that a wide variety of cabinet enclosure sizes, shapes, and designs are possible for the gaming system 100. For example, the cabinet panels 108, 110 (as well as the base panel and the top panel surface) may be combined into fewer elements or divided into additional elements. Additionally, the positions of the displays (e.g., first display device 120) and input and output devices can be rearranged with respect to one another. In some implementations, the gaming system 100 may include more or fewer components than described herein.

A player can interact with the gaming system 100 in various ways to direct wagering and game activities. The cabinet 105 may include player input systems and output systems generally designated as the player interaction area 112. In some implementations, the player interaction area 112 can be located on the front top side of cabinet 105 and, as shown, on a panel structure that extends outwardly from the gaming system 100 in a player's direction. The player interaction area 112 may contain player input and output systems, including a player control area 114 with one or more input devices 115, a player value acceptor and dispenser area 116, and player convenience input area 118. It should be appreciated that the player interaction area 112 can be placed in other suitable areas of the gaming system 100. In some implementations, the player input and output systems of player interaction area 112 can be positioned in areas apart from each other within interaction area 112. In some implementations, the player input and output systems can be positioned apart from each other such that the player input and output systems are not all contained in player interaction area 112.

In some implementations, the player control area 114 may include the input devices 115, such as buttons and touch sensitive areas, through with which players may interact with the gaming system 100 to direct game activities. The cabinet 105 can provide an easily accessible location and support for player input and output interactions with the gaming system 100, including gaming control interactions and value wagering interactions. Although the gaming system 100 illustrated in FIG. 1 shows the input devices 115 of the player control area 114 as physical controls (e.g., buttons), it is understood that in some implementations, a player's gaming control inputs could be made using physical controls (e.g., hardware buttons, levers, etc.), “soft” controls (e.g., software driven buttons) located on a gaming display and activated by player touch (e.g., touch screen interfaces), motion detection interfaces, etc. It should be appreciated that a player's gaming control inputs can be made using a suitable combination of input devices.

In some implementations, when a player depresses or selects one of the input devices 115, that input device 115 may cause requests, messages, and/or signals to be sent to one or more processors of the gaming system 100. The input devices 115 may be associated with, but are not limited to the following game controls: game selection button(s) (e.g., where more than one game is provided in a single gaming system 100); gaming denomination value selection button(s); wager selection button(s) for the player to indicate or select the desired wager value for a game; pay line selection button(s) for selecting the number of active pay lines in game implementations that provide multiple pay line wagering; reel spin button(s) for players to initiate one or more reels to spin in a game; a repeat last bet button for players to conveniently repeat the last game's preference and wager selections in a new game; a cash-out button for player extraction of available player credits; an attendant call button; and gaming information buttons such as show pay tables, show game rules, or show other game-related information. It should be appreciated that input devices 115 may include other suitable game control inputs.

The player value acceptor and dispenser area 116 may include one or more value acceptance devices 117a and value distribution devices 117b that allow the player to interact with the gaming system 100. The value acceptance devices 117a allow the player to input value (e.g., money, currency, paper ticket or voucher, etc.) to risk or otherwise place a wager (e.g., a monetary value) on one or more outcomes of a game. The value distribution devices 117b may return winnings to the player via some form of value distribution (e.g., currency, paper ticket or vouchers, credit on a player tracking card, credit stored in a central database, etc.). In some implementations, the value acceptance devices 117a may accept any one or more of the following from a player to establish a gaming credit balance: coins, bills, tokens, tickets/vouchers, player ID cards, credit cards, or other suitable forms of value. Thus, if the gaming system 100 accepts coins and bill, the value acceptance devices 117a may comprise a currency bill validator and a coin validator, and the value distribution devices 117b may comprise a currency bill dispenser and a coin dispenser, respectively. Likewise, if the gaming system 100 accepts paper tickets, the value acceptance devices 117a and the value distribution devices 117b may comprise a ticket acceptor that receives tickets or vouchers representing some monetary value, and a ticket printer, respectively. In some implementations, the ticket acceptor may include a bar code reader, or other appropriate code reader, for reading the encoded value contained by the player's ticket or voucher, and the ticket printer may contain a bar code printer or other appropriate code printer, for printing an encoded value onto a ticket or voucher to be dispensed. In some implementations, the value acceptance devices 117a and the value distribution devices 117b can accept and distribute more than one type of value. In some implementations, the player value acceptor and dispenser area 116 may include multiple different value acceptance devices 117a and multiple different value distribution devices 117b that accept different types of value from players and distribute different types of value to players.

In some implementations, upon receipt of some suitable type of value from the player, the value acceptance devices 117a can perform validation on the player supplied value using appropriate hardware readers (e.g., determining that the currency bills/coins/tokens/ticket/voucher/card are genuine). If the validation result is positive on player supplied value, the value acceptance devices 117a can generate a message/signal to a processor of the gaming system 100 that establishes a gaming credit balance for playing one or more games on gaming system 100.

In some implementations, the value distribution devices 117b dispenses a monetary value, or a representation thereof, from the gaming system 100 when a player chooses to “cash out” the gaming credit balance (e.g., remove value from the gaming system 100). The player may select an input device 115 associated with a cash out function. The input device 115 may cause a request/message/signal to be sent to a processor of the gaming system 100 to perform a cash out process. The player can cash out at any suitable time. When a player cashes out the value contained on a credit meter (not shown) of gaming system 100, a processor of gaming system 100 may cause a printer included in the value acceptance devices and the value distribution devices 117b to print and dispense a coded ticket or voucher through a dispensing slot to the player. The coded ticket or voucher may be a bar-coded ticket or any other suitable code (PDF517 coding or quick response (QR) coding). This ticket can then be used as value input at another gaming system, or converted to currency at a conveniently located kiosk or cashier counter located near the gaming system. Alternatively, the processor of gaming system 100 may cause a currency bill dispenser or a coin dispenser included in the value acceptance and value distribution devices 117b to dispense the value contained on the credit meter of gaming system 100.

Various combinations of the above value acceptance and value distribution arrangements are possible. The gaming system 100 may include other value acceptance and value distribution mechanisms in the player value acceptor and dispenser area 116. For example, the value acceptance devices 117a and the value distribution devices 117b may include a magnetic strip or chip card reader/writer in order to accept value from and transfer value to a magnetic strip or an embedded chip card. In other implementations, the value acceptance devices 117a and value distribution devices 117b may include hardware for transferring (and receiving) non-traditional currencies to players such as digital currencies (e.g., bitcoin). In some implementations, the gaming system 100 may update a record of the player's credit meter balance to a remote database.

In some implementations, the value acceptance devices 117a and value distribution devices 117b may include a card reader that accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming system 100 may be associated with the player account. Additionally, gaming system 100 may include a numeric or alphanumeric keypad (not shown) that enables player entry of a personal identification number or the like for secure access to card information.

In some implementations, a player convenience input area 118 may be included in the gaming system 100, as is shown in FIG. 1. In various implementations, player convenience input area 118 may have a variety of features and functions depending on the jurisdictional deployment of the gaming system 100. In some implementations, the player convenience input area 118 may house a magnetic strip card reader (not illustrated), integrated circuit chip card reader (not illustrated), or both, for reading cards associated with a player loyalty program. In some implementations, the player convenience input area 118 may include one or more value acceptance devices 117a and one or more value distribution devices 117b. Player loyalty programs, also referred to as player tracking systems, provide magnetic strip or chip cards to players for insertion into the gaming system 100 during play. These player loyalty/players tracking cards may be associated with a player account and are utilized by the card-issuing entity to monitor, or track a player's gaming activity and build loyalty through player rewards of a variety of types. The player convenience input area 118 may include an input mechanism such as input buttons (not shown) so that a player may input a personal identification number or other require player information associated with the player tracking card. Further, the input mechanism may also include a small display utilized to communicate player information to the player such as the player's current loyalty rewards.

In certain implementations, the player convenience input area 118 may include player convenience features such as a pocket for storage that allows players to store their personal items such as a mobile phone. The gaming system 100 may include one or more power charging ports (e.g., universal serial bus (USB) ports, etc.) that enables a player to charge their electronics or connect to services such as the Internet or food service. Further, player convenience input area 118 of the gaming system 100 may include buttons to request food or drink service if the gaming system is located in an establishment that has food and drink service. The gaming system 100 may be connected to a local or wide area network such that selection of the requested food or drink service may alert the establishment's hospitality staff to deliver the requested service directly to the gaming system 100.

The layout of the player control area 114, player value acceptor and dispenser area 116, and the player convenience input area 118 in gaming system 100 may be arranged differently than those disclosed and illustrated herein. The selections and arrangement of player device input locations and player device output locations on the cabinet 105 may be dependent upon the game buttons, the type of value wagered, and the player conveniences utilized in the deployment configuration of gaming system 100.

In some implementations, cabinet 105 includes the first game display device 120, which can be mounted atop or flush with a top panel surface of cabinet 105. The first game display device 120 can be, for example, a 27-inch liquid crystal display (LCD) display mounted in a widescreen orientation. However, any suitable display may be connected to gaming system 100 and placed in any suitable orientation. In the illustrated implementation, the first game display device 120 can be mounted within and framed by first display frame 122 which is, in turn, mounted upon lower cabinet body portion's top panel surface. In this manner, the first game display device 120 is both surrounded and secured within the first display frame 122 and raised above the cabinet's top panel surface. Additional features of the first display frame 122 are described below. Although not illustrated, it is understood that some implementations of the gaming system 100 may use a single first game display device 120 and not include additional game displays. For example, a single first game display device 120 may span the one or more portions of the cabinet 105 and extend upwardly away from cabinet 105 in place of additional display devices (e.g., display devices 130 and 134, described below).

In some implementations, cabinet 105 can support additional display devices. In some implementations, cabinet 105 may include an upwardly extending support structure (not illustrated) that extends upwardly from the rear side of cabinet 105 and configured to mechanically support one or more additional game display devices (e.g., display devices 130 and 134, described below).

Gaming system 100 may include a cabinet top light 128. In some implementations, the cabinet top light 128 is capable of illumination in a variety of colors and can be utilized to indicate and communicate conditions of the gaming system 100 to gaming players and service personnel.

In some implementations, the upwardly extending cabinet support structure (not shown) of cabinet 105 may conceal power and communication lines between (1) the control systems and components located within cabinet 105, (2) the displays mounted on the upwardly extending support structure, and (3) cabinet top light 128.

In some implementations, as illustrated in FIG. 1, gaming system 100 may include one or more additional display devices, such as a second game display device 130 and/or a third game display device 134. The second game display device 130 and the third game display device 134 can be disposed generally in a vertical relationship and generally in alignment with the first game display device 120. Like the first game display device 120, the second game display device 130 and the third game display device 134 can be LCD display device or other suitable display devices and can be mounted in any suitable orientation in some implementations. Further, like the first game display device 120, the second game display device 130 and/or the third game display device 134 can be mounted within and framed by second display frame 132 and third display frame 136, respectively. The second display frame 132 and the third display frame 136 can be attached to the upper cabinet support structure and can protect the second game display device 130 and the third game display device 134. In some implementations, one or more of the game display devices 120, 130, and 134 may not include a display frame. In some implementations, one or more of the game display devices 120, 130, and 134 can be housed within a same display frame.

In some implementations, the first game display device 120, the second game display device 130, and the third game display device 134 can be disposed at an angle from each other to form a player-facing concave arc. However, in some implementations, the angles between the game display devices 120, 130, and 134 may be adjustable and may be smaller or greater than the angles illustrated in FIG. 1. Further, it is understood that in some implementations the displays may be disposed in a common plane relative to each other.

It also should be appreciated that in various implementations a variety of display technologies may be utilized equivalently and interchangeably with a variety of implementations of the gaming system. Equivalent display devices may include, but are not limited to, variations of liquid crystal displays, light emitting diode displays, quantum dot light emitting diode (QLED) displays, electroluminescence (EL) displays, and plasma displays.

In some implementations, different sized display devices may be combined to display gaming data on gaming system 100. As a non-limiting example, a 27-inch widescreen LCD display may be combined with a 20-inch portrait-oriented LCD or a light emitting diode (LED) display. The display devices could include organic light emitting diode displays (OLED) or other suitable display devices. This combination may be used, for example, with a third scrolling banner LED display. In alternative implementations, one, two, three, or more displays could be used in a variety of positions and orientations. Any suitable combination may be used. It should also be appreciated that a processor of gaming system 100 may communicate with the disclosed first game display device 120, second game display device 130, and third game display device 134 through a video card of gaming system 100 to produce the visible aspects of a game.

In some implementations, one or more of the first game display device 120, the second game display device 130, and the third game display device 134 may be fitted with a transparent touch sensitive overlay for sensing player touch inputs into the gaming system 100. The touch sensitive overlays can communicate with a processor of gaming system 100 to enable the player to interact with a game available on gaming system 100.

In some implementations, curved displays may be used for one or more of the display devices on gaming system 100. Similarly, any of the displays used for gaming system 100 can be based on flexible display technologies. For example, it is possible to utilize flexible display technologies to create uniquely shaped curving, wavy, or tubular display structures to provide one or more of the display devices of gaming system 100. Additionally, in some implementations flexible display technologies can be used in combination with fixed flat screen technologies.

While the gaming system 100 has been described as implemented with video technologies, in some implementations, mechanical game reels with reel strips containing game indicia and step motor controllers may be employed to provide game information to a player. In some implementations, the reel strips may include printed symbols. In another implementation, the mechanical game reels may include flexible video display technology as the reel strips on mechanical game reels. Thus, games implemented in video form can readily be implemented with mechanical game reels utilizing such display technology. Alternatively, in other implementations mechanical game reels with reels strips having fixed symbols displayed along the reel strip could be used to implement the game.

Dependent upon a housing style used in some implementations of the gaming system 100, a variety of other display technologies may be utilized in combination with the gaming system disclosed herein. For example, the gaming system 100 may have one or more display devices in addition to the main game display devices(s) in some implementations. For example, the gaming system 100 may include a player tracking device having a player tracking display which displays various information to the player regarding the player's status. The gaming system 100 may also include other game-related displays such as the wager display and the gaming credit balance meter display. These additional game-related displays may be separate display devices or may be displayed on any one or more of the first game display device 120, the second game display device 130, or the third game display device 134.

The gaming system 100 may also include cabinet lighting that can be used to, among other functions, attract players. In the example gaming system 100 illustrated in FIG. 1, attractive cabinet lighting is provided by frame accent lighting 138. The frame accent lighting 138 can be placed around any number of structures of gaming system 100. For example, the frame accent lighting 138 can be placed around the first display frame 122, the second display frame 132, the third display frame 136, and/or player interaction area 112.

The frame accent lighting 138 may include multiple components. In some implementations, the side edge pieces of the first display frame 122, the second display frame 132, the third display frame 136, and the edge structure of player interaction area 112 can be made of a translucent or transparent plastic or other suitable materials. Linear arrays, or strips, of light emitting diodes (LEDs) (not shown) on circuit boards may be mounted below or on the surface of the side edge pieces. In some implementations, the circuit boards are flexible circuit boards. These LED strips and transparent or translucent coverings may surround one or more gaming system displays frames, as well as the player interaction area, to highlight these areas. It should be appreciated that other suitable types of lighting (e.g., electroluminescence lighting) may be utilized for frame accent lighting 138.

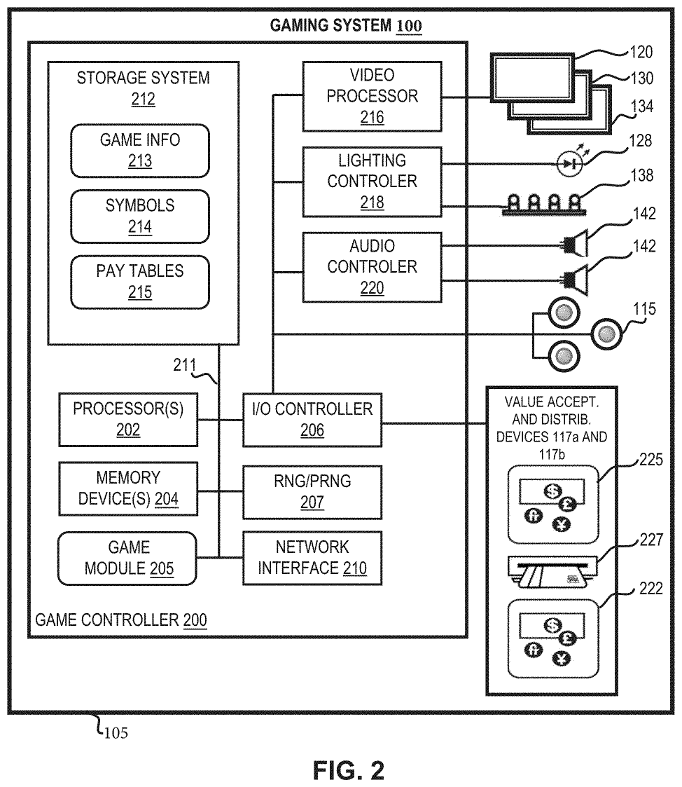

In some implementations, the individual LEDs mounted on the LED strips are of a type that can emit red, green, and blue light. In an alternative implementation, separate LEDs are used for the light colors. In some implementations, the LEDs or LED strips can be electrically connected and can be controlled by a cabinet lighting controller (e.g., cabinet lighting controller 218 in FIG. 2) in conjunction with a processor of the gaming system 100 to selectively mix the emitted light colors in a manner to create any color. The cabinet lighting controller can flash and vary lighting as desired. For example, cabinet edge lighting can change and flash in combination with music rhythms or in combination with game events. Other suitable variations are possible.

In some implementations, the cabinet 105 may include LED strip lighting or LED rope lighting to accentuate the cabinet and enhance the attractiveness of the gaming system 100 to players. LED rope lighting is a number of small light-emitting diode bulbs linked together and encased in a plastic, polyvinylchloride, or other suitable material to create a string of lights. For example, in one implementation illustrated in FIG. 1, the cabinet 105 includes cabinet accent lighting 140. In some implementations, the cabinet accent lighting 140 is LED rope lighting mounted flush with the front side edge of the cabinet side panels 108. The LED rope lighting can generate any of suitable colors, and are controlled by cabinet lighting controller and a processor of the gaming system 100 to selectively mix the emitted light colors in a manner to create any color in the same manner as the frame edge lighting.

In various implementations, the gaming system 100 includes one or more audio speakers 142 and appropriate driving electronics and sound cards so that game players may experience pleasing audio aspects of the gaming system 100. Audio is desirable to attract and maintain player interest in the gaming system 100. The gaming system 100 may also emit attraction sounds during any idle period of the gaming system 100. Game audio may add to the player's enjoyment of the gaming system 100 by providing music and sound effects designed to enhance and compliment the gaming experience. In FIG. 1, the audio speakers 142 are shown mounted on the upper corners of the second display frame 132. Any suitable number of additional audio speakers 142 may be provided on additional display frames or on cabinet 105 as desired.

The audio speakers 142 designed for emitting bass vibrations may be included in some implementations. Placement of the audio speakers 142 may be selected to enhance the sound emitting characteristics of the gaming system 100. For example, bass speakers or additional speakers 144 may be mounted inside cabinet 105. Further, it is envisioned that in some implementations sound processing such as multichannel processing and surround sound processing are included in gaming system 100. Audio jacks for attachment of player headphones may also be provided in some implementations of gaming system 100 for the player to further enhance the audio experience of the game and to block out noise from other gaming systems.

In some implementations, the front panel 110 of cabinet 105 includes a removable panel or door, which can be opened for access to internal control system and technology components that are housed within cabinet 105 (discussed hereinbelow with respect to FIG. 2). The removable panel or door can be locked in some implementations. The front panel 110 may be flanked on vertical sides by cabinet side panel extensions 146 which serve to define a space below the player interaction area 112 for players to place their feet and legs while they are playing the gaming system 100 in a seated position. A foot rest 148, which may be cushioned, can positioned below the player interaction area 112 to enhance a player's ergonomic comfort while playing the gaming system 100. In some implementations, the edges of the player interaction area 112 may be ergonomically cushioned as well.

The gaming system 100 may be constructed using other suitable alternative forms and styles of gaming system housings that are not shown. For example, the cabinet 105 may have fewer or greater number of display devices for displaying games and game-related information to the player. If multiple display devices are used, the display devices may be of similar size, shape, and orientation or the display devices may be divergent from each other in one or more of their respective characteristics. The one or more display devices can be supported by, mounted upon, or contained within the cabinet 105 which can comprise a variety of shapes, sizes, and forms. The cabinet 105 can: protect and house the operational electronics; adequately support the display(s) in a position easily viewable for a seated or standing player, as necessary; and/or provide an easy location and support for all necessary player input/output systems, including gaming control interactions and wagering interactions. For example, in some implementations the gaming system 100 may include a housing style referred to as a “slant top” gaming device that is designed to be operated with the player comfortably seated. In this arrangement, generally, the gaming display(s) and all player input and output controls are located on a low, wide, surface that extends forwardly from the player on a horizontal plane and then slopes upwardly and away from the player's seated location.

In some implementations, housing styles of the cabinet 105 of gaming system 100 may include bar top or table top housing arrangements. These housings are generally small enough to be placed on top of an existing bar or table while providing the requisite gaming system housing functions of protection of/access to gaming electronics, displays, and player input and output functions described above.

In some implementations, the cabinet 105 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

FIG. 2 shows a functional block diagram illustrating an example of a game controller 200 of a gaming system 100 in accordance with aspects of the present disclosure. The gaming system 100 can include a cabinet 105, one or more player input devices 115, one or more value acceptance devices 117a and distribution devices 117b, one or more display devices 120, 130, and 134, a cabinet top light 128, accent lighting 138, and one or more audio speakers 142, which can be the same or similar to that previously described herein. Additionally, implementations of the game controller 200 may include one or more processors 202, one or more memory devices 204 (e.g., random access memory, read only memory, etc.), one or more game modules 205, one or more input/output (I/O) controllers 206, one or more random number generators 207, one or more network interfaces 210, one or more communication channels 211 (e.g., a data bus), one or more video processors 216, one or more lighting controllers 218, and one or more audio controllers 220. In accordance with aspects of the present disclosure, the game controller 200 is configured to perform specialized game functions and operations, consistent with the implementations described herein. The functional elements shown in FIG. 2 cooperate, on a broad and general level, to function as a gaming system providing the functionality and operations detailed below. Such functionality and operations can be embodied in hardware, software, or a combination thereof. It is understood that the below described hardware includes the structures described, as well as the functional or operational equivalents of such structures. Further, it is understood that the below-described functions and operations can be performed by hardware, digital circuitry, computer software, computer firmware, or functionally equivalent combinations thereof.

The processor 202 can be one or more general-purpose processors, special-purpose processors, or other programmable data processing apparatuses providing the functionality and operations detailed herein. In some implementations, the processor 202 is specially configured with arithmetic logic units and math co-processors, also known as floating point units, for executing one or more games consistent with the various implementations disclosed herein. In some implementations, the processor 202 includes registers for holding instructions or other data, and cache memory for storing data for faster operation thereupon.

A controller, in some implementations, is a device or a software program that manages or directs the flow of data between two entities. Often, controllers are special purpose circuitry or software that solve a technical communications problem between different technology systems. In some implementations, a controller functions as an interface between two systems while managing the communications between the systems. In another implementation, a controller functions as an interface between a processor and a peripheral device and functions to control the peripheral device.

The memory device 204 and storage system 212 can be operatively and/or communicatively connected to the processor 202. In some implementations, the memory device 204 and/or the storage system 212 includes one or more types of memory structures. For example, the memory structures can include random access memory (RAMs) units, read only memory (ROMs), flash memory (e.g., solid state drives (SSDs)), electrically erasable/programmable read only memory (EEPROMs), etc. It should be appreciated that in some implementations, communication between the memory device 204, the storage system 212, and the processor 202 or another controller, encompasses the processor or controller accessing the memory device 204 and/or the storage system 212, exchanging data with the memory device 204 and/or the storage system 212 (e.g., reading/writing data to the memory device 204), or storing data to the memory device 204 and/or the storage system 212.

The memory device 204 and/or the storage system 212 may store program code, game code (collectively the “code” or “program instructions,” such as game module 205), and operational data (e.g., game info 213, symbols 214, and pay tables 215, or other suitable data) used in the operations of the game controller 200 to provide a gaming system that executes the gaming functions described hereinbelow. In an alternative implementation, the code and the operational data for the operation of the game controller 200 may be stored in a distributed manner such that some code is stored in memory device 204 (or storage system 212) and other code is stored remotely from the game controller 200. In some implementations, the code and the operational data used the operation of the game controller 200 includes, for example, basic input and output function data, instruction fetching data, bus and network communication protocol data, and like data for an operational gaming system. In some implementations, the code (e.g., the game module 205) and the operational data (e.g., game info 213, symbols 214, and pay tables 215, or other suitable data) used for the execution of the gaming features includes, for example, game image data, game rule data, pay table data, game mode and timing data, gaming value and wager parameter data, and random or pseudo-random number generation data.

In addition to the memory device 204 described above, in some implementations, the code and operational data for the operation of the gaming system described above may be stored in the storage system 212. The storage system 212 can be removable game cartridges or flash drives, a compact disk ROM, a digital versatile disk (DVD) optical storage technology, or suitable other fixed, non-transitory computer-readable storage devices. In some implementations, part or all of the code and operational data for operation of the gaming system or for execution of the game features may be stored in a remote memory structure and be downloaded to the memory device 204 via a network connection.

In some implementations, the game controller 200 may utilize any combination of computer-readable memory devices, such as random-access memory devices (RAMs), unalterable memory devices (ROMs), and mass storage devices for securely storing and securely communicating the software components or code that facilitate game play and other functions of the game controller 200. The memory device 204 may store software components or code that include various game data and game related control and execution software. In some implementations, the software components stored in the memory device 204 may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the game controller 200.

In some implementations, the memory device 204 and the storage system 212, with the software components, code, operational data, and other information may be secured and authenticated by authentication software stored in an unalterable memory device within the housing of the game controller 200. The game controller 200 may also include application specific integrated circuits (ASICs) to perform the security and authentication functions. At various time or events, such as before each play of a game, at a predetermined interval, upon transfer of any game data or any software components from a mass storage to the memory device 204, or upon demand, the game controller 200 (using a processor such as a processor 202 or a separate ASIC) may execute an authentication routine and perform an authentication of any software component or other data of the game controller 200. In some implementations, the software components of the gaming system 100 and game controller 200 may be prepared for authentication via creation and storage of an encrypted signature unique to one or more of the software components.

In some implementations, an encrypted signature may be created by utilizing a hash function on a software component or code to form a message digest (e.g., a hash of the software component) followed by a key encryption of the message digest to form an encrypted signature unique to the software component. In some implementations, the key encryption may be public key encryption, private key encryption, or any suitable key encryption schema. The encrypted signature may be stored with the gaming system software component, for example, in a mass storage device or an unalterable memory. During a software component authentication, the gaming system 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and the game controller 200 may allow game play to proceed. In some implementations, when the message digests do not match, the game controller 200 may determine that the software component under authentication may be corrupted or fraudulent and game play may be halted. It should be appreciated that the game controller 200 may perform other suitable security and authentication checks on the game data or software components. Such authentication and security devices and functions are unique to gaming and casino industry to minimize or prevent fraud in gaming devices and gaming systems.

For a player to interact with the gaming system 100, the game controller 200 receives and processes player inputs from, e.g., input devices 115, and the game controller 200 causes processed results to be output or communicated to the player. In some implementations, the player inputs are recognized and processed or directed for processing by input/output (I/O) controller 206. Further, the I/O controller 206 may process and direct player outputs for communication to the player. The I/O controller 206 can function as the intermediary between the processor 202 and one or more input devices to control information and data flow therebetween. The I/O controller 206 may also function as the intermediary between the processor 202 and one or more output devices to control information and data flow therebetween. The I/O controller 206 is configured to understand the communication and operational details (such as hardware addresses) for the attached input devices and output devices. In this manner, processor 202 can be freed from the operational details of the peripheral I/O devices in some implementations. For example, in some implementations where an input or output device is changed or upgraded, the I/O controller 206 can be changed or updated without changing other gaming system components.

In some implementations, a player deposits value into a gaming system by inserting some form of currency or value into a value acceptor 225 for game play. Alternatively, a player deposits value into a gaming system by inserting an encoded paper ticket into a value acceptor 225 for game play in some implementations. The value acceptor 225 can be combined with a currency reader and validator, and a code reader for reading value encoded on paper tickets. In some implementations, the gaming system 100 may include different hardware for the paper ticket reader from the currency reader and validator. The value acceptor 225 may read, validate and communicate the amount of the inserted value to the processor 202. The processor 202 can establish a gaming credit balance for the player based on the communication from the value acceptor 225. The processor 202 can also communicate the player's credit balance on a credit balance meter display of the gaming system 100. During game play, the processor 202 may process a player's wagers and determine an amount of credits to debit from the player's credit balance. When a winning outcome is obtained, the processor 202 is configured to determine an amount of credits to add to the player's credit balance. It should be appreciated that the gaming system 100 may use one or more different processors to perform such calculations.

As previously mentioned with respect to FIG. 1, gaming system may use one or more of a variety of value acceptance systems. In some implementations, the value acceptor 225 could include magnetic strip or chip card readers to accept and transfer value. The value acceptor 225 may also be configured to accept and transfer non-traditional currencies such as digital currencies. In these implementations, I/O controller 206, a processor 202, or both may be configured with appropriate control instructions to communicate with the value acceptor 225 and extract value from the inserted item containing value. In some implementations, use of a magnetic strip or embedded chip card, for example a bank card, for value insertion requires the processor 202 to communicate, via network interface 210, with devices external to a gaming system 100.

In some implementations, a card reader 227 may be included in gaming system 100 to accept player loyalty cards. For example, the card reader 227 can extract account identifying information from the card and utilizes this information to access the associated account information stored remotely via the network interface 210. In implementations where player loyalty/player tracking systems are used with the gaming system 100, a player's loyalty account and record of gaming activity can be stored in a networked storage location or database. In some implementations, the processor 202 is configured to record the player's gaming activity in the memory device 204 and/or the storage system 212 during the duration of loyalty card insertion. When the loyalty card is removed from the card reader 227, recorded gaming activity is uploaded, via the network interface 210, to the remote storage location associated with the player's account in some implementations. In this manner, the player's gaming activity can be further processed and analyzed, and the player can be awarded loyalty rewards based upon his activity data at the gaming system 100.

In various implementations, the input devices 115 receive a player's game inputs and communicates the player's game inputs to the processor 202. The player's game inputs may include, but are not limited to, wager amounts, pay line selections, game control signals, game selections, and cash-out requests/signals. In some implementations, the input device 115 may generate signals/requests based on button presses, touch screen activations, or voice control. In some implementations, the player-initiated signals can be communicated to the processor 202 by the I/O controller 206. Further, the player-initiated signals may direct and inform execution of the game instructions stored in the memory device 204 and configured to be executed by the processor 202 in some implementations.

In some implementations, the gaming system 100 may include mechanical game reels and other electro-mechanical components to provide game displays and game outcomes (not shown). For example, mechanical game reels (e.g., mechanical game reels rotatable about a common axis) may include indicia or symbols fixedly positioned around the periphery of the mechanical game reels. The indicia or symbols fixedly positioned around the periphery of a mechanical game reel may form a reel strip. The indicia or symbols fixedly positioned on reel strip may comprise a set of symbols for that reel strip or reel. The indicia or symbols on the mechanical game reels are generally associated with separate, detectable reel stop positions. In some implementations, the mechanical game reels can be set into a spinning/rotation motion by pulling a lever or pushing a button of the gaming system 100. In some implementations, the gaming system 100 can stop the game reels by allowing the mechanical game reels to stop naturally, or actuating a suitable mechanical or electro-mechanical reel brake on a random timing basis. When the mechanical game reels stop rotating, the gaming system 100 may, using suitable detection mechanisms, determine one or more displayed stop positions of the mechanical game reels. Since the displayed stop positions of the mechanical game reels can be associated with respective indicia or symbols, the gaming system 100 can determine what combination of indicia or symbols are displayed at the stop positions. The gaming system 100 can also determine whether the displayed indicia or symbols result in one or more winning symbols and/or winning symbol combinations for a game outcome.

In some implementations, the displayed stop positions (e.g., corresponding to displayed indicia) can be determined using random numbers associated with the displayed stop positions/indicia/symbols of the mechanical reels. In some implementations, the processor 202 is configured to execute stored program code and instructions which generate random numbers or pseudo-random numbers for determining the displayed stop positions of the mechanical reels. The gaming system 100 can use the randomly generated numbers to determine which stop positions of the reels should be displayed for a game outcome.

In some implementations, a random number generator (RNG) 207 is a software module configured to be executed by the processor 202 for the generation of a true random or pseudo-random number. The code for RNG 207 may be stored in the memory device 204 or the storage system 212. The RNG 207 generates random numbers for use by the gaming system 100 during game execution. In some implementations, the gaming system 100 can utilize the random numbers for the random selection of one or more symbols (e.g., stop positions) along mechanical game reels.

In some implementations, the gaming system 100 uses video-based reels as simulations of the mechanical reels to provide game displays of game outcomes. In some implementations, the video-based reels are used in place of mechanical reels. In some implementations, the video-based reels are used in conjunction with mechanical reels or other mechanical components. Like a mechanical game reel, a video-based reel can be associated with a reel strip, where the reel strip includes a set of symbols or indicia. The set of symbols or indicia for a reel strip may be fixed or dynamic in various implementations. In some implementations, indicia or symbols can include, but are not limited to, numbers, letters, geometric figures, symbols, images, character, animations, blank symbols (e.g., the absence of symbols), or any other suitable graphical depiction. The gaming system 100 may include one or more video-based reels for a game. The gaming system 100 may include a particular reel strip associated with a particular video-based reel. In some implementations, each video-based reel can be associated with a separate reel strip (e.g., a separate set of symbols). The reel strips can be the same or different for different video-based reels. It should be appreciated that the language “reel strip(s)” is used merely for illustration purposes throughout this disclosure. In some implementations, predetermined reels strips may be used. In other implementations, a reel strip is a representation of a set of symbols, where symbols in the set of symbols are associated with a probability of being determined or generated for display in the visible symbol display areas of a video-based reel. Different reel strips (e.g., different sets of symbols) may include the same symbols associated with the same or different probabilities of being determined or generated. In some implementations, different reel strips may include different symbols. It should be appreciated that in some implementations, indicia or symbols can be used independently of a video-based reel. That is, in some implementations, games on gaming system 100 do not use video-based reels or reel strips for displaying of game outcomes. In some implementations, where games on gaming system 100 do not use video-base reels or reel strips, the gaming system may also use random number determinations for game outcomes.

Returning to random number generation, symbols in the reel strips or sets of symbols can be associated with numbers for video-based reels, (or associated with reel stop positions of mechanical game reels). In some implementations, when the RNG 207 selects a number, a processor in conjunction with the memory devices 204 of the gaming system 100 can correlate the selected number to an associated symbol (or respective reel stop position) to determine what symbol (or reel stop position) has been randomly selected. In various implementations, once symbols (or reel stop positions) are randomly selected based upon the random numbers generated by the RNG 207, the processor 202 can evaluate the displayed patterns of symbols or randomly determined numbers to determine one or more game outcomes. It should be appreciated that in some implementations, gaming system 100 may include a hardware based random number generator that is in communication with processor 202 to supply random numbers for random game symbol determination purposes. The hardware based random number generator may be incorporated into the processor 202 or can be separate from the processor 202.

Returning to FIG. 2, the game controller 200 controls the function and output of output devices utilized by a gaming system. In various implementations, the I/O controller 206 serves as an interface unit between the processor 202 and output devices, such as video processor 216, cabinet lighting controller 218, audio controller 220, and value dispenser 222.

In some implementations, the video processor 216 communicates with the processor 202 to render at least some of the game graphics, video displays, and information on one or more video display devices (e.g., game display devices 120, 130, and 134). In some implementations, the video processor 216 includes one or more processors, controllers, and/or graphics cards for processing the game images, outcomes, and animated displays and coordinating the processed data to be display between, among, or across any or all display devices. In various implementations, this may include being configured to simulate objects and the movement of objects which represent video game reels containing symbol sets.

It should be appreciated that in certain other implementations where gaming system 100 includes physical mechanical game reels to display game symbols or other game features, reel controllers and stepper motors can be provided in lieu of or in addition to video processor 216.

In implementations which utilize cabinet lighting as described with respect to FIG. 1, a cabinet lighting controller 218 may be utilized to coordinate and control the color and timing of cabinet lighting displays with processor 202. In certain implementations which utilize sound design, processor 202 may utilize audio controller 220 to coordinate and control the sound emissions. In some implementations, audio controller 220 may include one or more audio processing cards for generating sound and for driving the one, two or more speakers 142 that may be included with the gaming system 100.

In various implementations, players may request their remaining credit value by selecting one of the input devices 115, which in turn makes a request or initiates a signal that is communicated to the processor 202, such as via the I/O controller 206. In some implementations, the signal triggers a readout of the player's credit balance from a credit balance meter and the processor 202 initiates a value dispensing signal which, in turn, can be communicated to the value dispenser 222. In some implementations, the value dispenser 222 can be controlled to issue the player's credit value using any of the types of value discussed herein. In some implementations, the player's credit value may be issued to the player via a printed and dispensed encoded paper ticket or token which the player can then exchange at a special purpose kiosk or cashier location for the monetary value encoded into the ticket or token. In some implementations, the processor 202 can direct the value dispenser 222 to issue to the player an appropriate amount of coin or bills directly to the player. Additionally, or alternatively, in some implementations, the player may have the option to electronically direct the credit value to an account associated with the player. It should be appreciated that any suitable combination of forgoing may be available at gaming system 100.

In some implementations, the game controller 200 may communicate with one or more devices outside the gaming system 100. For example, gaming system 100 may be connected to a larger network via a local area network (LAN) or a wide area network (WAN). The game controller 200 may communicate with one or more central servers, controllers, or remote devices to execute games, establish credit balances, participate in progressive jackpots, etc. In some implementations, network communications and connections can be accomplished via a network interface 210. Network interface 210 can be a digital circuit board or card installed in game controller 200 to provide network communications with external devices. Network interface 210 may include wired and/or wireless communication hardware.

In some implementations, various additional features and functions are performed by the game controller 200. For example, the game controller 200 may be specially configured with software to track game play events that occur on the gaming system 100. In some implementations, the game controller 200 may audit recorded monetary transactions, including wager amounts, game outcomes, game winnings, and game payouts that occur through the value dispenser 222. Further, some implementations of gaming system may include security software to assist in protecting the gaming system 100 from tampering or alteration attempts.

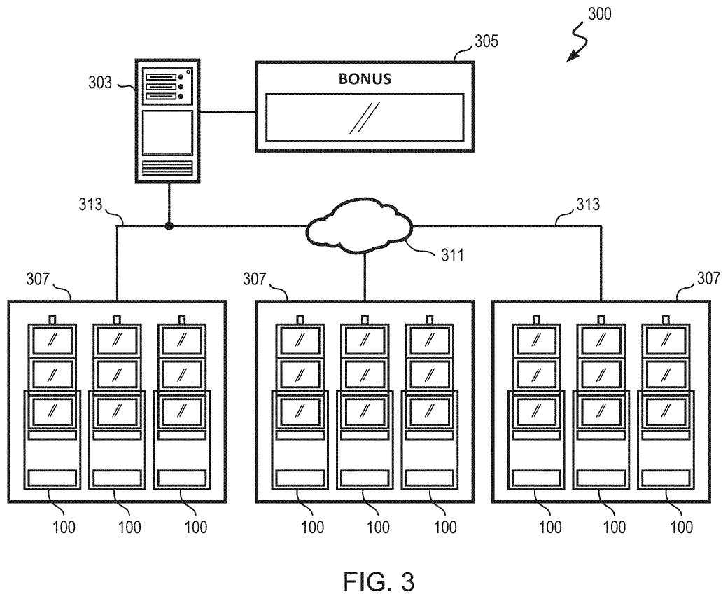

FIG. 3 illustrates an example of an environment 300 for implementing systems and methods in accordance with an implementation of the present disclosure. The environment 300 includes a bonus server 303 and a bonus display 305 that are functionally connected with one or more banks 307 of one or more gaming systems 100 via a network 311 and one or more wired or wireless communication links 313. The bonus server 303 can be one or more computing devices comprising hardware, software, or a combination thereof that manages bonus games provided by the gaming systems 100 of one or more of the banks of gaming systems 307. In some implementations, the bonus server 303 functions to collect and maintain funds for one or more bonuses, display the values of the bonuses using the bonus display 305, and provide the bonuses to the gaming systems 10. For example, the bonus server 303 can maintain different pools of funds corresponding to different bonus levels (e.g., small, large, and grand/jackpot bonuses). In some implementations, the bonuses can be progressive bonuses in which the bonus server 303 incrementally accumulates the pools from wagers made at the gaming systems 100.

The bonus display 305 can include one or more display devices that display values of the bonuses managed by the bonus server 303. The bonus display 305 can be a video display or a mechanical display device. For example, the bonus display 305 can be a cathode ray tube (CRT) display, a liquid crystal display (LCD), a light-emitting diode (LED) display, a flip card display, a reel display, etc. The bonus display 305 may be located so as to be viewable by players of the gaming systems 100 in a same location or a same bank 307. In some implementations, the banks 307 of gaming systems 100 can be collocated within view of the bonus display 305. While FIG. 3 shows a single bonus display 305, it is understood that the environment 300 can include more than one bonus display 305. In some implementations, multiple bonus displays 305 may be used, such as when some of the banks 307 are at different physical locations. In some implementations, the individual gaming systems 100 can include respective bonus displays 305. For example, the gaming systems 100 can include respective top displays (e.g., display device 134 in FIG. 2) repeating the function and information provided by the bonus displays 305. The bonus displays 305 connected to the network 311 may have substantially the same information displayed. For example, while individual banks 307 or the gaming systems 100 may have different games or themes, such banks 307 and the gaming systems 100 may participate in bonus games having a common bonus pool that is managed and paid out by the bonus server 303 based on certain game features occurring.

The banks 307 can include one or more of the gaming systems 100 that may be at the same or different locations as the bonus server 303 or one another. The locations can be different spaces within a single facility (e.g., casino, airport, or mall) or in spaces at separate locations. In some implementations, a bank 307 may include a single gaming system 100.

The network 311 can be a wired or wireless computer network that functions to exchange information between the bonus server 303 and the gaming systems 10. The network 311 can be, for example, a peer-to-peer network, a local area network, a wide area network, or the Internet. The network 311 may be located in a single location or spread over multiple locations and may be connected to other networks.

The gaming systems 100 in the network 311 may include displays for a main game and a bonus game (e.g., game display devices 120, 130, and 134). The bonus game may be common to the gaming systems 100, while one or more of the gaming systems 100 may provide different base games. The bonus may be provided when certain criteria at one of the gaming systems 100 are achieved in the bonus game. The criteria may be, for example, the display of a particular symbol or symbol combination, or a particular outcome of the bonus game.

In some implementations, the gaming systems 100 may participate in multiple bonus games having respective bonus awards. For example, a first bonus may be available when the player makes a small wager, a second, larger bonus may be available when the player makes a larger wager, and a third, still larger bonus may be available when the player makes an even larger wager. It understood, however, that the different bonus levels available may not be associated with wagers of a player. Instead, for example, all of the different bonus levels may be available to the player and the award of a particular level may correspond to the outcome of the bonus game.

### Gaming System Operation

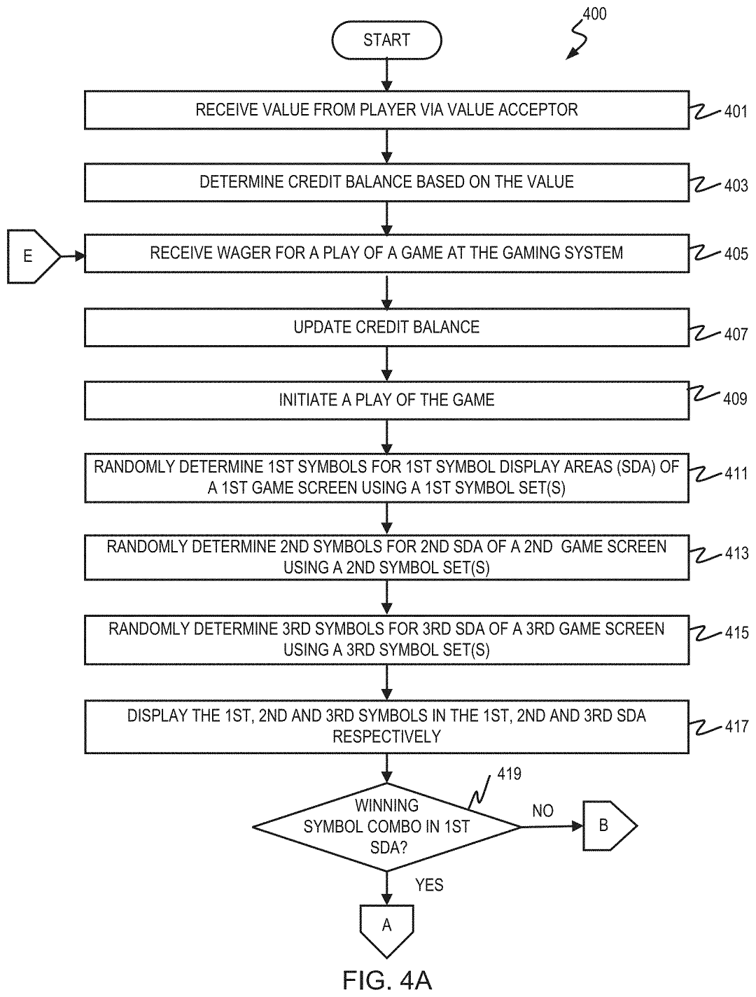

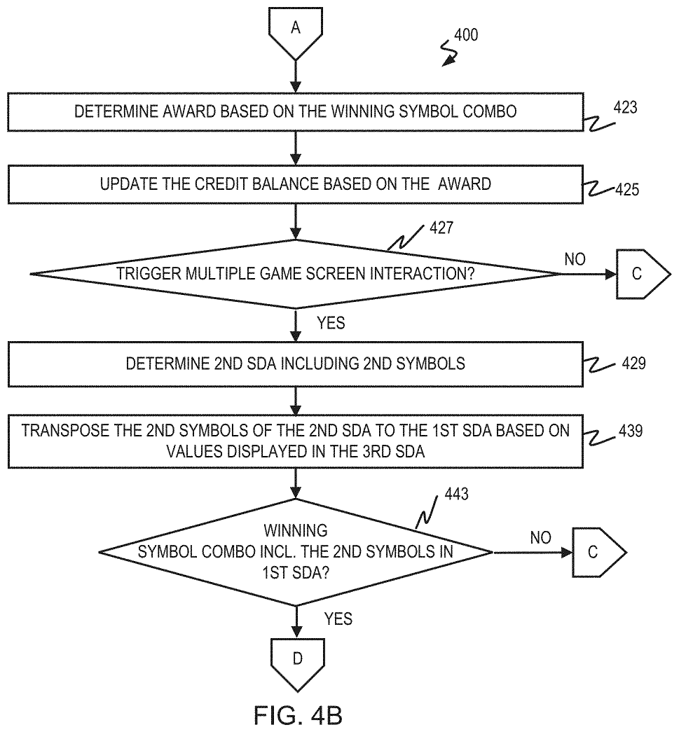

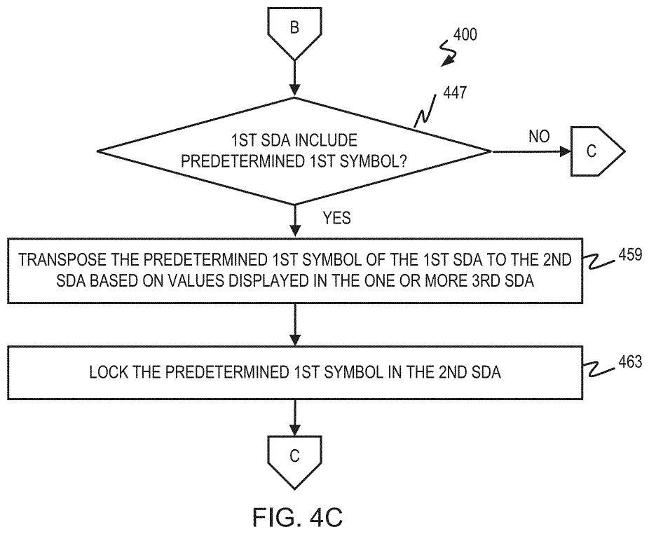

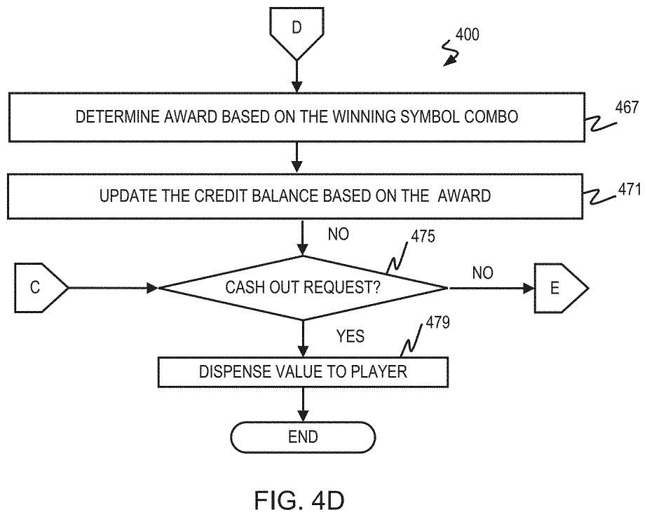

The flow diagrams in FIGS. 4A-4D illustrate functionality and operations of systems, devices, processes, and computer program products according to various implementations of the present disclosure. Each block in FIGS. 4A-4D can represent a module, segment, or portion of program instructions, which includes one or more computer-executable instructions for implementing the illustrated functions and operations. In some implementations, the functions and/or operations illustrated in a particular block of the flow diagrams can occur out of the order shown in FIGS. 4A-4D. For example, two blocks shown in succession can be executed substantially concurrently, or the blocks can sometimes be executed in the reverse order, depending upon the functionality involved. Additionally, in some implementations, the blocks of the flow diagrams can be rearranged in different orders. Further, in some implementations, the flow diagrams can include fewer blocks or additional blocks. It is also noted that each block of the flow diagrams and combinations of blocks in the flow diagrams can be implemented by special-purpose hardware-based systems that perform the specified functions or acts, or combinations of special-purpose hardware and computer-executable instructions.

In some implementations, a play of a game begins when the gaming system receives a monetary value from a player (e.g., block 401). In other implementations, a play of the game begins when the gaming system receives a wager (e.g. block 405). In some implementations, a play of the game can start after block 427, without being triggered by any primary game or base game. The play of the game can end when a first part of the game is complete and a second part of the game is not triggered or otherwise initiated. In some implementations, the play of the game can also end when the gaming system receives a request to cash out (e.g., block 475, “Yes”). In some implementations, blocks 475 and 479 are not part of a play of a game. In alternative implementations, blocks 475 and 479 are part of a play of a game.

Turning to block 401 in FIG. 4A, in some implementations, the system (e.g., gaming system 100) performing the operation, process or method 400 receives a monetary value or other value via a value acceptor device (e.g., value acceptor 225). In block 403, the gaming system determines a credit balance based on the monetary value received in block 401. In block 405, the gaming system receives a wager for a play of a game from a player via an input device (e.g., input device 115) using, e.g., the credit balance determined at block 403. In some implementations, the gaming system allows the player to place a minimum wager, a maximum wager, or other suitable wager therebetween. Also, in some implementations, an amount of the wager may determine the value of some of the awards available from the game. And, in some implementations, the amount of the wager may activate a multiple game screen interaction, as described above and detailed below. For example, the gaming system can activate the multiple screen interaction when it receives a maximum wager at block 405. In some implementations, the gaming system determines whether the credit balance determined at block 403 includes enough credits to enable the wager received at block 405. The gaming system may prevent the player from placing the wager and initiating play of a game if the credit balance determined at block 407 is not large enough to support the wager. If enough credits are not available in the player's credit balance, the gaming system may provide the player with an option to insert additional value to obtain the minimum credit level or to cash out of the gaming system. A cash out request may trigger the gaming system to issue a cash out request or signal to a value dispenser.

In some implementations, the wager received at block 405 funds one play of a game, whereas a player's credit balance may permit multiple plays of a game for a gaming session. In some implementations, the gaming system starts a gaming session in response to receiving monetary value from a player (e.g., at block 401) and ends when a player cashes out of a gaming system (e.g., at block 443) or the player's credit balance is below a minimum wager amount (e.g., zero or other suitable number) and the player does not replenish their credit balance. A gaming session may include zero, one or more plays of a game or multiple plays of a game or multiple plays of different games (e.g., where a gaming system includes multiple different games to play) at a gaming system. At block 407, the gaming system updates the credit balance determined at block 403. In some implementations, the credit balance is updated based on the amount of the wager received at block 405. It is understood that some implementations of the method 400 may not include block 407 and that the gaming system may update the credit balance at other times, such as at the completion of the game.

In some implementations, depending on the amount of the wager received at block 405, the gaming system enables the player to select particular pay lines across reel symbol positions displayed in one or more game screens. In some implementations, the gaming system selects the active pay lines automatically based on the wager received at block 405. It is understood that some implementations of the gaming system may not include pay lines and, as such, the method 400 may not perform any pay line selections. For example, the amount of wager may make all available pay lines active. Further, the gaming system may use ways-pays (e.g., all-ways pays) as an alternative to pay lines. It is further understood that some implementations may use “ways-pays” or “ways to win” as an alternative or in combination with wagered pay lines. In some implementations, ways-pays determines wins based on every possible combination in a slot machine game. For example, a five-reel slot machine with three visible symbol display areas can have 243 different pay lines, which can be all possible combinations when evaluating symbols from the left reel to the right reel. In some implementations, ways-pays can be viewed as being independent of pay lines or including all possible pay lines. In some implementations, with ways-pays, a player can win based on any winning combination from left to right. In some implementations, additional ways-pays are available where a gaming system evaluates symbols from left to right or right to left. Ways-pays can alternatively be understood as all the symbols being evaluated as combinations of scatter symbols, where a scatter symbol is a symbol that triggers a payout regardless of whether it appears on a pay line.

At block 409, the gaming system initiates a play of the game. The initiation can be automatically triggered in response to the wager received at block 405 or it can be manually triggered in response to receiving an input via an input device. For example, for a game that includes video-based reels, the player may press a spin button on the gaming system (e.g., input device 115) or actuate a lever to start spinning the video-based reels of the gaming system (or randomly generating symbols using other methods) for the play of the game. It should be appreciated that video-based reels, reels, slot machine reels, gaming reels, etc. used throughout the specification may refer to mechanical reels, electro-mechanical reels, or video reels. It should further be appreciated that although many examples illustrated in the specification describe the gaming system in terms of slot machines with reels, other gaming systems may be used, including gaming systems without reels.

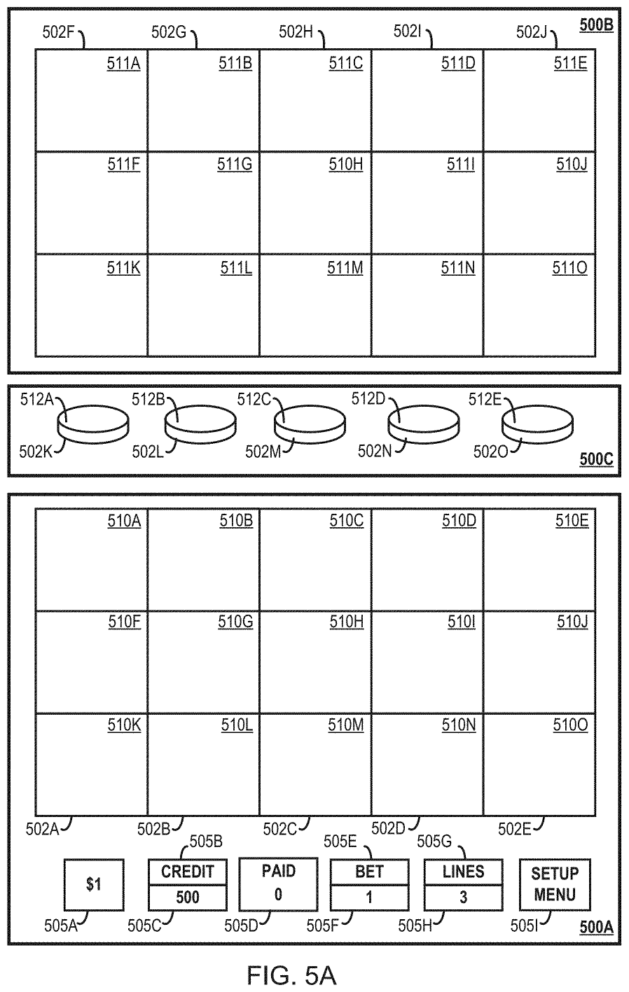

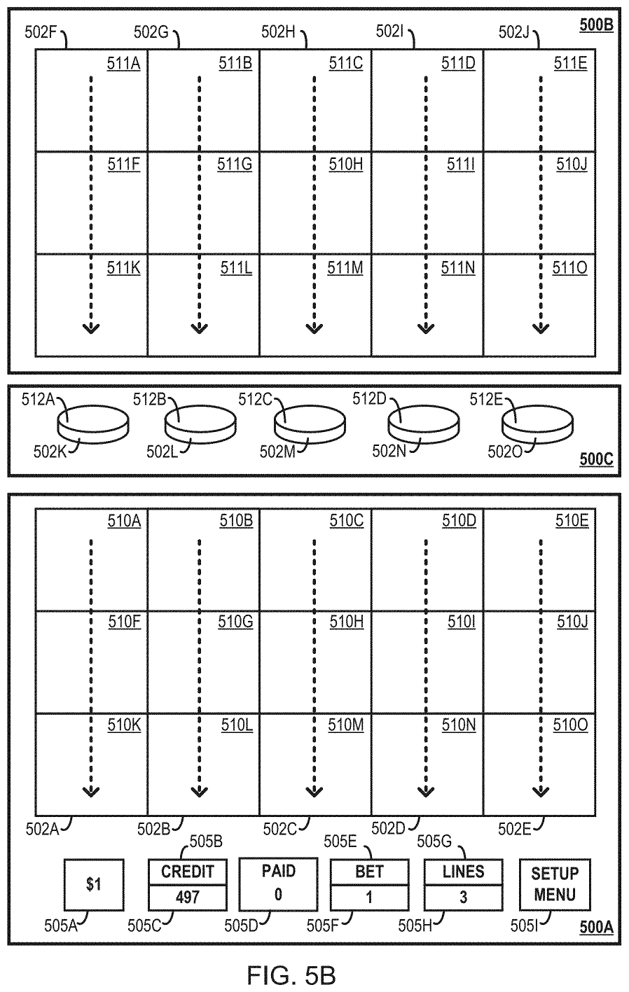

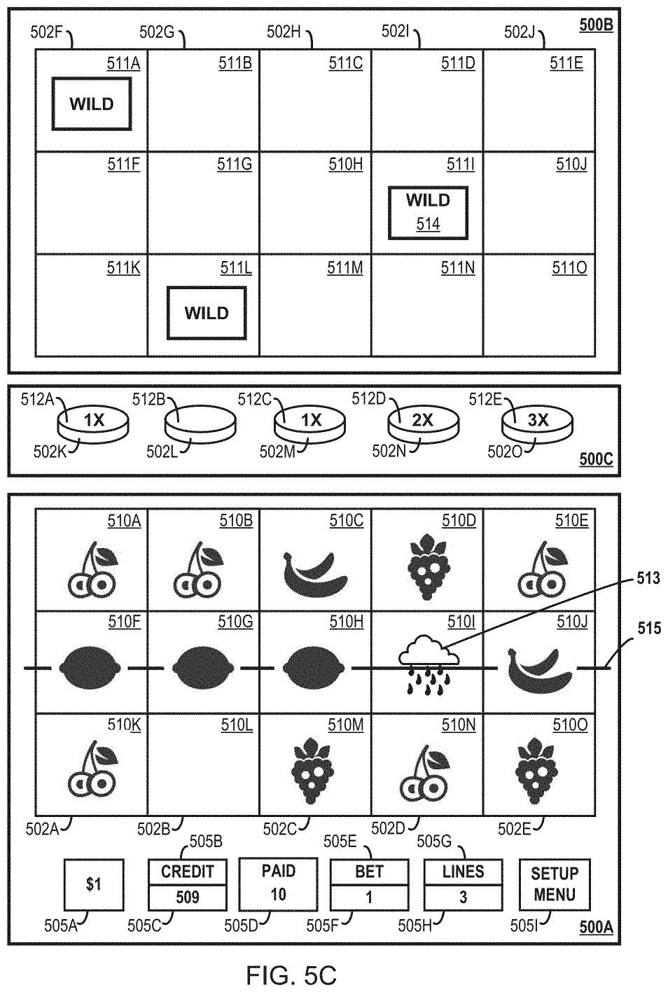

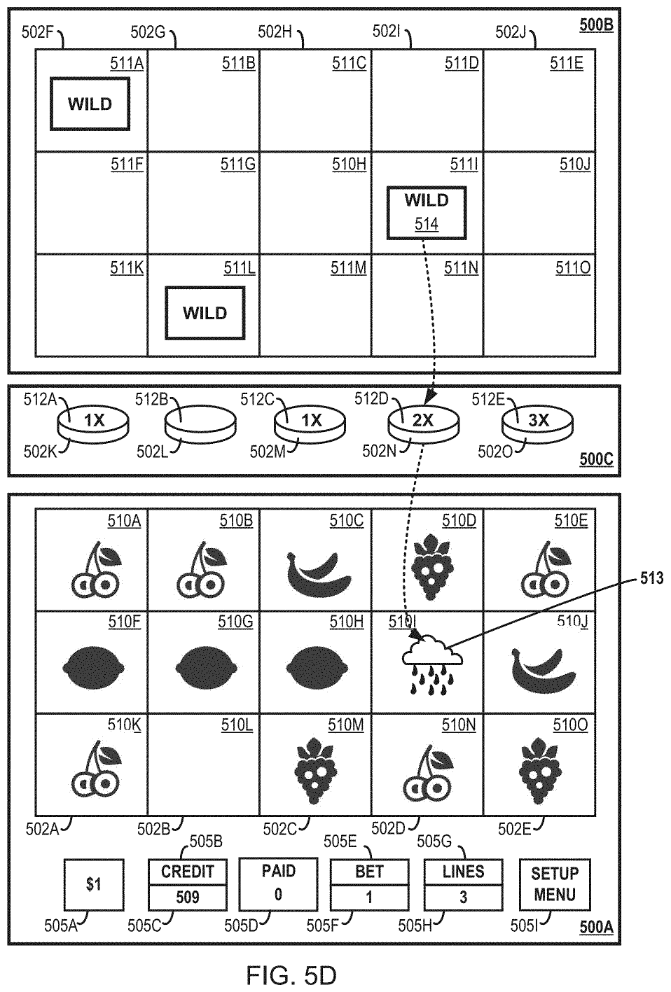

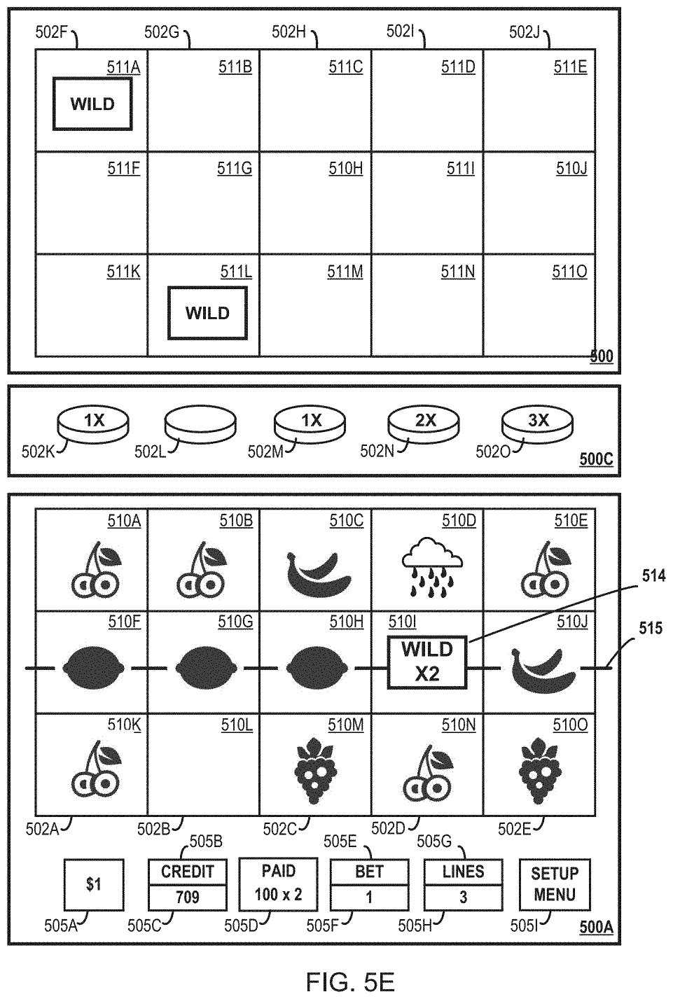

At block 411, the gaming system randomly determines, using a random number generator (e.g., random number generator 207), first symbols for symbol display areas (e.g., symbol display areas 510A-510O in FIG. 5A) of a first game screen (e.g., first game screen 500A in FIG. 5A) using one or more first symbol sets corresponding to the first game screen. In implementations in which the reels are rendered using a video display (e.g., using video processor 216 and display devices 120, 130, and 134), the gaming system can randomly select the first symbols from the one or more first symbol sets (e.g., sets comprising symbols 214). As non-limiting examples, the first symbol sets can include graphical indicators depicting numbers, letters, geometric figures, playing cards, images, characters, animations, blanks (e.g., the absence of symbols), or the like. Additionally, the first symbols sets may include modifier symbols, such as cash award symbols (e.g., 100 credits or $10) and award multiplier symbols (e.g., a 10×increase in an award of a winning combination). Further, the first symbol sets may include special or designated symbols (e.g., wild symbols, trigger symbols, scatter symbols, free game symbols, etc.). In some implementations, types of symbols included in the first symbol sets may be different. In some implementations, the special symbols are collections symbols (e.g., persistent symbols or storage symbols) that the gaming system stores in one or more symbol display areas over more than one play of a game. As the stored collection symbols persist for more than one play of the game, the collection symbols can accumulate over several plays of the game. In some implementations, the gaming system can activate additional game functionality, such as a bonus game, based on quantities and/or types of collection symbols accumulated during a gaming session.

At block 413, the gaming system randomly determines, using the random number generator, second symbols for symbol display areas (e.g., symbol display areas 511A-511O in FIG. 5A) of a second game screen (e.g., second game screen 500B in FIG. 5A) using one or more second symbol sets corresponding to the second game screen in a same or similar manner to that described above regarding block 411. In some implementations, the one or more second symbol sets corresponding to the second game screen include symbols that are the same or similar to those included in the first symbols sets of the first game screen. In other implementations, the one or more second symbol sets corresponding to the second game screen may comprise blank symbols and special symbols. For example, the one or more second symbol sets may consist of blank symbols (e.g., empty or other null symbols), bonus or trigger symbols (e.g., symbols that among other features may trigger a bonus game, a bonus award, or otherwise trigger other game features), wild symbols (e.g., symbols that substitute or function as other symbols in combination evaluations), or other suitable special symbols. It is understood that, in some implementations, the gaming system performs block 413 depending on the wager received at block 405 (e.g., a maximum wager).

At block 415, in one implementation, the gaming system randomly determines, using the random number generator, the indicators (also referred to herein as third symbols) for the linking display areas (e.g., symbol display areas 512A-512E in FIG. 5A). The linking display areas may be displayed in the first game screen, the second game screen, in a third game screen (e.g., third game screen 500C in FIG. 5A), or split between the first and second display screens. The random determination of the indicators for the linking display areas can use one or more third symbol sets corresponding to the linking display areas in a same or similar manner to that described above regarding block 411. In some implementations, the one or more third symbols sets are comprised of blanks and values, wherein the values represent a quantity of symbols (e.g., 1, 2, 3, 4, and 5) or an award multiplier (e.g., 1×, 2×, 3×, 4×, and 5×).

For example, one or more of the linking display areas may display a randomly-determined indicator that increases or modifies the action or impact of a second symbol transposed or moved from the second game screen to the first game screen. In one implementation, the gaming system may associate an indicator of “3” with a linking display area. In such an implementation, any winning combinations formed on the first game screen including a second symbol transposed via the “3” linking display area may be increased by a 3× multiplier value. In one implementation, one or more of the linking display areas may include an indicator that increases the quantity of the second symbol moved from the second game screen to the first game screen. For example, the gaming system may associate a value of “3” with the linking display area. In such an implementation, a second symbol transposed to the first game screen via the “3” linking display area results in three instances of the second symbol being transposed to the first game screen. In some such implementations, the instances of the second symbol may be displayed in the vertically-aligned reel of the first game screen corresponding to the reel of the second game screen that displayed the transposed second symbol. In some implementations, the gaming system may randomly display three instances of the second symbol in the first game screen. For example, the gaming system may cause one of the second symbols to fall (e.g., rain down) from the second symbol display screen via the linking display area and disappear and also create three instances of the second symbol that fall into three randomly-selected symbol display areas of the first game screen. It is understood that, in some implementations, the gaming system performs block 415 depending on the wager received at block 405 (e.g., a maximum wager).

At block 417, in some implementations, the gaming system causes one or more display devices (e.g., display device 120, 130, 134) to display the first, second, and third symbols determined for the first, second, and third game screens at blocks 411, 413, and 415, respectively. For example, the gaming system may display reels as spinning before slowing and stopping to display the determined symbol in visible symbol display areas. In some implementations, the gaming system may render reels using a video display. In some implementations, the gaming system may populate symbol display areas on one or more reels using the determined symbols. In some implementations, the gaming system displays the symbols in all of the game screens a substantially the same time. In some implementations, the gaming system can offset the times at which the symbols are determined at blocks 411-415 or displayed at block 417. It is understood that, in some implementations, the gaming system displays the second symbols and the third symbols at block 417 depending on the wager received at block 405 (e.g., a maximum wager).

At block 419, the gaming system evaluates the first symbols determined at block 411 and displayed in the first game screen at block 417 to determine whether they include one or more winning symbols and/or winning symbol combinations. In some implementations, the gaming system evaluates the winning symbol combinations based on the pay lines wagered upon by a player, ways-pays, scatter symbols, or other suitable evaluation criteria. The gaming system may evaluate the player-selected pay lines, gaming system assigned pay lines, or pay lines assigned as active in some other manner for the play of the game. In some implementations, the gaming system determines the winning symbols or winning symbol combinations based on a predefined pay table (e.g., pay tables 215). For example, if the pay table indicated that at least three of the same LEMON symbols is a winning symbol combination on an active pay line and results in a predetermined award, the gaming system may evaluate the determined and displayed symbols for groupings of at least three LEMON symbols. If the gaming system determined and displayed at least three LEMON symbols on adjacent reels and along an active pay line, the gaming system may determine that the three LEMON symbols is a winning symbol combination based on the pay table. It should be appreciated that a pay table may include any suitable number of different winning symbols and/or winning symbol combinations and associated awards. In some implementations, a pay table may indicate that as few as one symbol may be associated with an award. Alternatively, any suitable two or more symbols may be used to form winning symbol combinations that result in an award. It should be appreciated that in some implementations, the gaming system may determine winning symbols and/or winning symbol combinations prior to the symbols determined in block 411 being displayed in block 417.

At block 419, if the gaming system determines that the first symbols displayed in the first game screen at block 417 do not include a winning symbol combination (e.g., block 419 is “No”), then the method 400 may proceed to block 447 of FIG. 4C, as indicated by off-page connector “B,” as is detailed below. On the other hand, at block 419, if the gaming system determines that the symbols determined for the first game screen at 411 and displayed at block 417 include a winning symbol combination (e.g., block 419 is “Yes”), then the method 400 may proceed to block 423 of FIG. 4B, as indicated by off-page connector “A.” At block 423, the gaming system determines one or more awards based on the winning symbols and symbol combinations determined at block 419. For example, the gaming system can identify awards corresponding to a winning symbol combination using the pay table referenced at block 419. At block 425, the gaming system can update the credit balance determined at block 407 based on the amount of the award or awards determined at block 421. It is understood that some implementations of the method 400 may not include block 425 and that the gaming system may update the player's credit balance at other times, such as at the completion of the game at block 471.

At block 427, the gaming system determines whether a multiple game screen interaction has been triggered. In some implementations, the gaming system triggers the multiple game screen interaction based on an output from a bonus controller. In some implementations, the gaming system randomly triggers the multiple game screen interaction based on an output from the random number generator. In some implementations, the gaming system randomly triggers the multiple game screen interaction after occurrence of a threshold number of events since trigging a previous multiple game screen interaction (e.g., after a number of wagers, a number of games, or a period of time). In some implementations, the gaming system triggers the multiple game screen interaction based on determining that the symbols displayed at 417 include a trigger symbol, a number of trigger symbols, a particular combination of trigger symbols, a particular arrangement of trigger symbols, or a particular sequence of trigger symbols. For example, the gaming system may trigger the multiple game screen interaction in response to a trigger symbol being displayed by one or more of the symbol display areas of the first game screen.

While FIG. 4B illustrates the multiple game screen interaction being triggered at block 425, it is understood that in some implementations, the multiple game screen interaction can be activated at block 405 based on an amount of a player's wager at block 405 or based on other suitable triggering mechanisms. For example, the multiple game screen interaction can be activated by a player placing a maximum bet of the gaming system. Also, in some implementations, the method 400 does not include block 425 and the multiple game screen interaction can be activated solely based on an amount of a player's wager at block 405. For example, in some implementations, reels including the multiple game screen interaction can be incrementally activated (e.g., 1, 2, 3, 4, or 5 reels) in correspondence with increasing wager amounts (e.g., 10, 20, 30, 40, or 50 credits). It is also understood that, in some implementations, the method 400 can start after block 425, without such game being triggered by the game initiated at block 411, such that blocks 427-465 provide a standalone game.

If the gaming system determines that the multiple game screen interaction has not been triggered (e.g., block 427 is “No”), then the method 400 proceeds to block 475 of FIG. 4D, as indicated by off-page connector “C,” as is detailed below. On the other hand, if the gaming system determines the multiple game screen interaction has been triggered (e.g., block 427 is “Yes”), then at block 429, the gaming system evaluates second symbols determined at block 413 and displayed on the second game screen at block 417 to determine symbol display areas of the second game screen displaying second symbols.

In some implementations, the first symbol display areas correspond to the second symbol display areas based on their respective locations. For example, in implementations in which the first game screen (e.g., game screen 500A) is an M row×N column array of symbol display areas (e.g., a 3×5 array of symbol display areas 510A-510O as illustrated in FIG. 5A) representing a first set of reels (e.g., reels 502A-502E) and the second game screen (e.g., game screen 500B) is M row×N column array of symbol display areas (e.g., a 3×5 array of symbol display areas 511A-511O) representing a second set of reels (e.g., reels 502F-502J) vertically stacked in alignment with the first set of reels, the positions of the symbol display areas of the first screen may respectively correspond to the positions of the symbol display areas of the second game screen (e.g., symbol display areas 510A can correspond to symbol display areas 511A). It is understood that the first game and second game screens can be arrays having greater numbers of symbol display areas (e.g., a 5×5 array) or fewer number of symbol display areas (e.g., a 1×5 array). It is also understood that the first game and second game screens can be of different sizes (e.g., a 3×3 array instead of a 3×5 array) such that some, but not all, of the symbol display areas of the second game screen correspond to the symbol display areas of the first game screen. It is further understood that in some implementations there may be no correspondence between symbol display areas of the first game screen and the symbol display areas of the second game screen. In such implementations, symbols from second game screen can be transposed via the linking display screen to one or more randomly-selected symbol display areas of the first game screen. Further, in some implementations, the linking display screen (e.g., display screen 500C) can be a 1×N array (e.g., 1×5) having linking display areas vertically aligning with the reels of the first game screen and the second game screen such that the symbol display areas of the reels of the first and second game screen correspond to the individual linking display areas of the third game screen. It is understood that the third game screens can be of a different size. For example, in implementations in which the first game screen (e.g., game screen 500A) is 3×5 array of symbol display areas (e.g., symbol display areas 510A-510O) representing a first set of reels (e.g., reels 502A-502E) and the second game screen (e.g., game screen 500B) is 3×5 array of symbol display areas (e.g., symbol display areas 511A-511O) representing a second set of reels (e.g., reels 502F-502J) vertically stacked in alignment with the first set of reels, the third game screen can be another 1×5 array having linking display areas corresponding one-to-one with the 5 reels of the first and second game screens. In some other implementations, the third game screen can be a 1×3 array providing three linking display areas or portals for transposing symbols between the first and second game screens.

At block 439, the gaming system transposes one or more of the second symbols of the second game screen determined at block 429 to the first game screen. In some implementations, transposing includes moving the second symbols through the corresponding linking display areas of the third game screen. For example, as detailed above, the third game screen can be a linking display area (e.g., a portal) connecting a reel of the second game screen to one or more reels of the first game screen. In some implementations, the second symbols are transposed from their symbol display areas of the second game screen to one or more randomly-selected symbol display areas in the first game screen. In some implementations, the second symbols are transposed from their symbol display areas of the second game screen to corresponding symbol display areas in the first game screen.

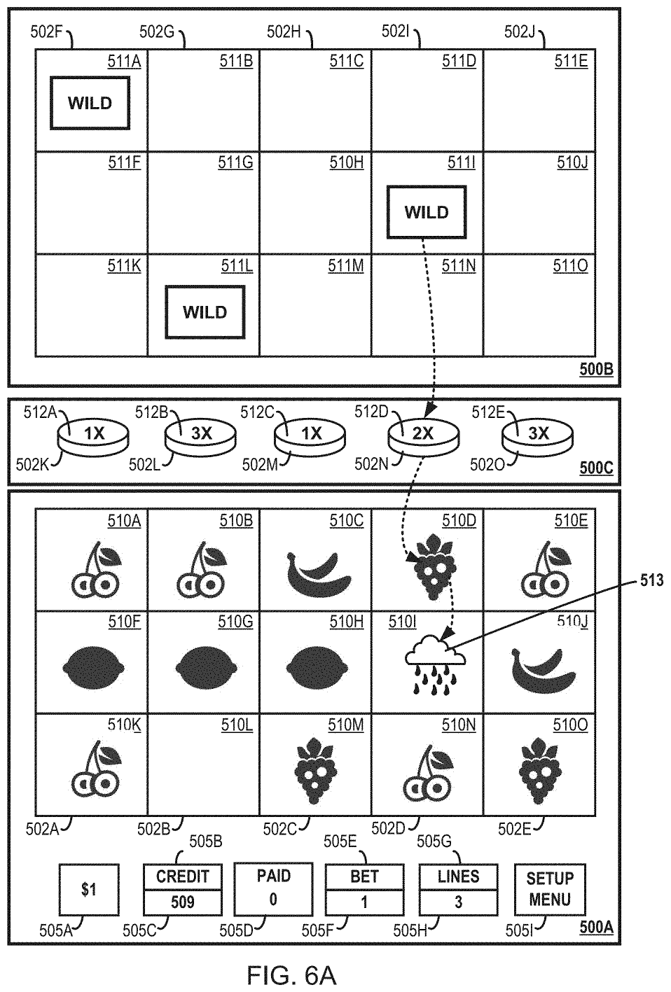

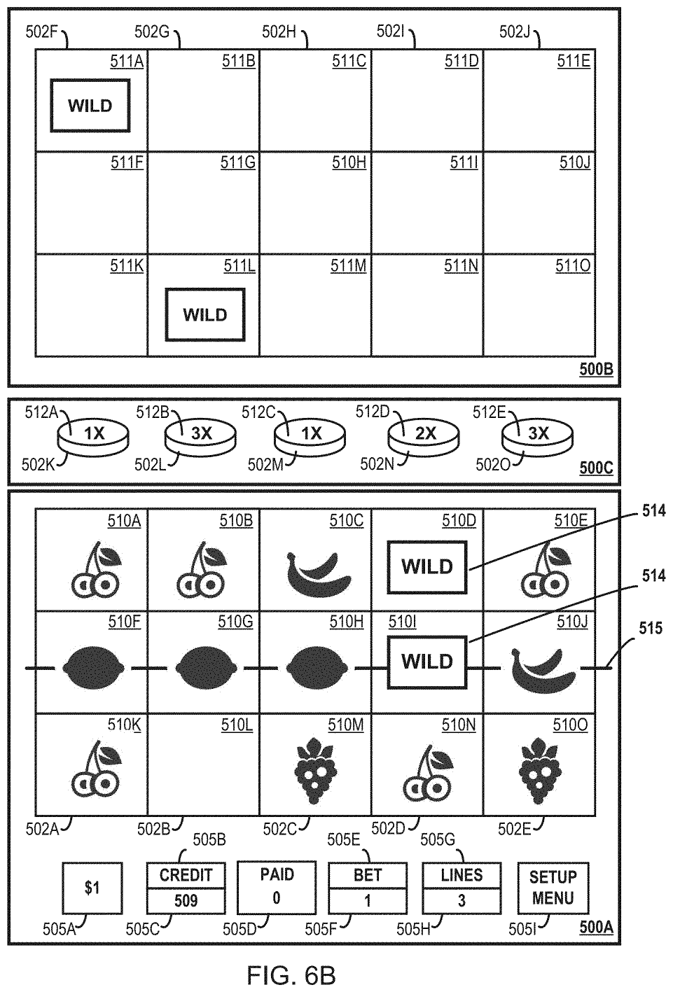

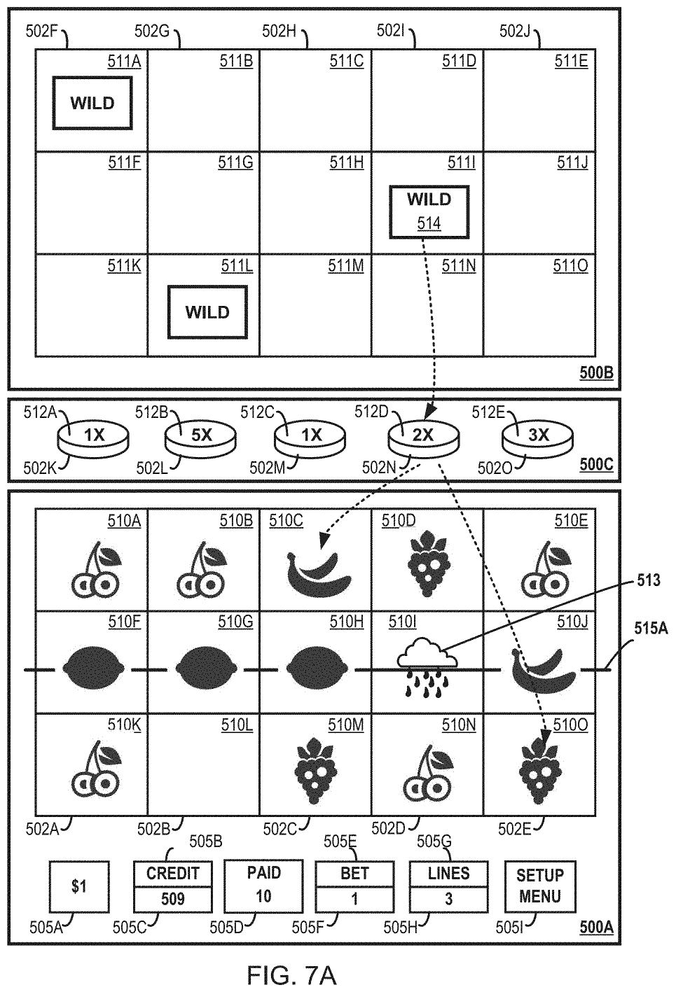

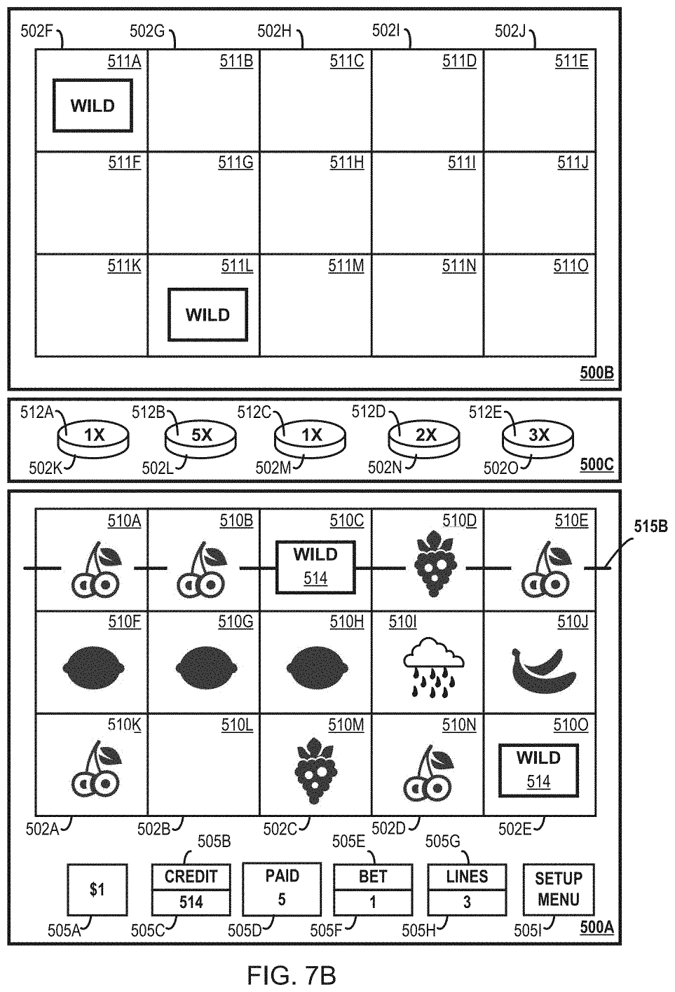

In some implementations, the linking display areas may have indicators that may affect an amount (e.g., the impact of, value of, or quantity of) associated with the second symbols transposed to the first game screen. For example, as illustrated in FIGS. 5D-5E below, the gaming system can assign a multiplier value to a second symbol transposed to the first game screen via a linking display area based on an indicator associated with the linking display area. Also, as illustrated in FIGS. 6A-6B and 7A-7B below, an indicator associated with the linking display areas of the third game screen can increase the quantity of the second symbol transposed to the first game screen via the linking display area. It is understood that, while FIGS. 5D-5E, 6A-6B, and 7A-7B illustrate a second symbol transposed from the second game screen and replacing first symbols in the first game screen, in some implementations, the second symbol can modify or combine with the first symbols. For example, the gaming system may display the second symbol or a value indicated by the second symbol together with the first symbol, without replacing the first symbol, such that both are evaluated in combination with the first symbols to determine winning symbol combinations. Also, in some implementations, the second symbol may modify the first symbol. For example, the gaming system may add an award multiplier indicated by the second symbol to the first symbol that increases the value of an award for a winning symbol combination determined at block 467.

At block 443, the gaming system evaluates the symbols displayed in the first game screen at block 439 to determine whether the first symbols displayed by the symbol display areas of the first game screen in combination with the one or more second symbols transposed to the first game screen via the linking display areas at block 429, create any new winning symbol combination(s), or trigger any bonus outcomes or other game features. The evaluation and determination can be performed in a same or similar manner to that previously described at block 419. If the gaming system determines that the symbols displayed in the first game screen at block 439 do not include any new winning symbol combinations (e.g., block 443 is “No”), then the method 400 may proceed to block 475 of FIG. 4D, as indicated by off-page connector “C,” as is detailed below. On the other hand, at block 443, if the gaming system determines that the symbols displayed at block 439 include a winning symbol combination (e.g., block 443 is “Yes”), then the method 400 may proceed to block 467 of FIG. 4D, as indicated by off-page connector “D.” At block 467, the gaming system determines one or more awards based on the symbol combinations determined at block 443 in a manner that is the same or similar to that previously described with regard to block 423. At block 471, the gaming system updates the credit balance determined at block 407 or block 425 based on the amount of the award or awards determined at block 467. It is understood that some implementations of the method 400 does not include block 471 and that the gaming system may update player's credit balance at other times, such as at the completion of the game at block 479.

At block 475, the gaming system may receive a request or signal to end game play or “cash out” via an input device (e.g., an input device 115) of the gaming system (e.g., which would end the gaming session). In such a situation, the gaming system may dispense a value to the player, through a dispenser (e.g., value dispenser 222) based on the player's gaming credit balance as illustrated in block 479 and the method 400 ends. If the gaming system has not received a request or signal to end game play at block 475 (e.g., the player continues the gaming session to play another play of the game), the method 400 may return to block 405, as indicated by off-page connector E. The gaming system may receive, via a player input device, an input for another play of the game and continue method 400 from block 411. However, in some implementations, the input may not be accepted if the player has fewer credits than the player's selected wager amount.

Turning back to block 447 in FIG. 4C, in some implementations, if the gaming system determines that the symbols displayed in the first game screen at block 417 do not include any winning symbol combinations at block 419, then the gaming system determines whether the symbol display areas of the first game screen include a predetermined first symbol. The predetermined first symbol can be a special symbol, such as a WILD symbol. At block 447, if the gaming system determines that the symbols displayed in the first game screen at block 439 do not include any predetermined first symbols (e.g., block 447 is “No”), then the method 400 may proceed to block 475 of FIG. 4D, as indicated by off-page connector “C,” which is detailed above. On the other hand, at block 447, if the gaming system determines that the symbols displayed in the first game screen at block 417 do include at least one predetermined first symbol (e.g., block 447 is “Yes”), then the method 400 may proceed to block 459. At block 459, the gaming system transposes the predetermined first symbols of the first display screen determined at block 447 in the symbol display areas to the second game screen determined at block 451 via the linking display areas in a same or similar manner to that previously described regarding block 439. That is, in some implementations, predetermined symbols displayed on the first game screen may float, fly, or otherwise be drawn towards a linking display area (e.g., a portal) and disappear while substantially simultaneously reappearing on the second game screen and move to predetermined or randomly selected symbol display areas of the second game screen. In some implementations, transposing the one or more first symbols in the second game screen via the linking display area at block 439 includes moving the predetermined first symbols from the first game screen to one or more of the symbol display areas of the second game screen. In some implementations, the transposing of the predetermined first symbols includes moving them through one of the linking display areas in a same or similar manner to that previously described above regarding moving second symbols to the first game screen. In some implementations, the movement of the one or more predetermined symbols depends on the associated indicators of the corresponding linking display areas through which the predetermined symbols pass.

At block 463, the gaming system can lock predetermined first symbols displayed in the second game screen at block 459 in some implementations. Locking the predetermined first symbols can include maintaining the predetermined first symbols at the transposed second symbol display areas without replacement in one or more subsequent plays of a game during a player's gaming session. In some implementations, the predetermined first symbols may be locked for a predetermined number of plays of the game. For example, the first symbol may remain locked for a single, next play of the game or some other suitable random or predetermined number of next plays of the game such as for five next plays of the game. In other implementations, the predetermined first symbol may be locked for the remainder of the player's gaming session. A locked predetermined first symbol can remain locked until a triggering event (e.g., such as determined at block 427) in a subsequent game causes the gaming system to transpose the predetermined first symbols in the second game screen to the first game screen, as previously described regarding blocks 427-439. The method 400 may proceed to block 475 of FIG. 4D, as indicated by off-page connector “C,” which is detailed above.

FIGS. 5A-8C show example images of game screens 500A, 500B, and 500C displayed by a gaming system (e.g., gaming system 100) in accordance with aspects of the present disclosure. More specifically, FIGS. 5A-8C illustrate example screen shots of game screens that may be displayed by one or more display devices (e.g., display devices 120, 130, 134) in some implementations of the gaming system. In some implementations, the game screens 500A, 500B, and 500C may be displayed on first display device 120 of gaming system 100 illustrated in FIG. 1. However, any other suitable display device may be used.

More specifically, FIGS. 5A-8C illustrate the game screen 500A including game reels 502A-502E, the game screen 500B including game reels 502F-502J, and the game screen 500C including linking display areas 502K-502O. In some implementations, the reels 502A-502J comprise sets of reels of a video slot machine. The reels 502A-502E, the reels 502F-502J, and the linking display areas 502K-502O can be respectively arranged substantially side-by-side so as to form three rectangular arrays. As such, the reels 502A-502E appear like a M-row by N-column reel array (e.g., a 3×5 array) in the game screen 500A, the reels 502F-502J appear like a M-row by N-column reel array (e.g., a 3×5 array) in the game screen 500B, and the linking display areas 502K-502O appear like a 1-row by N-column reel array (e.g., a 1×5 array), wherein each reels 502A-502E, reels 502F-502J, and linking display areas 502K-502O are respectively aligned to appear like a vertical stack. It is understood that game reels and linking display areas 502A-502O can be displayed with different amounts of separation or no separation. It is also understood that, while FIGS. 5A-8C show the game screens 500A and 500B as including gridlines delineating the symbol display areas 510A-510O and 511A-511O for the sake of clarity, it is understood that some implementations may not include some or all of the gridlines. For example, in some implementations, the symbol display areas 510A-510O and 511A-511O are not displayed within separate boxes. It is also understood that the game screens 500A, 500B, and 500C can be displayed using a single display device (e.g., display device 120), two display devices (e.g., display devices 120 and 130), or respective display devices (e.g., display devices 120, 130, and 134).

The reels 502A-502E include symbol display areas 510A-510O (also referred to herein as symbol display positions), the reels 502F-502J include symbol display areas 511A-511O, and linking display areas 502K-502O include indicator display areas (also referred to herein as symbol display areas) 512A-512E. As illustrated, in some implementations the reels 502A-502E may be vertically aligned with reels 502F-502J, and linking display areas 502K-502O, respectively. More specifically, the symbol display areas 510A, 510F, and 510K of reel 502A may vertically align with the symbol display areas 511A, 511F, and 511K of reel 502F, and the indicator display area 512A of linking display area 502K. In such arrangement, the symbol display areas 510A, 510F, and 510K of some implementations represent symbol display areas of the reel 502A that may correspond respectively to symbol display areas 511A, 511F, and 511K, which represent symbol display areas of reel 502F. Also, the symbol display areas 510B, 510G, and 510L of reel 502B may vertically align with the symbol display areas 511B, 511G, and 511L of reel 502G, and the indicator display area 512B of linking display area 502L. In such arrangement, in some implementations, the symbol display areas 510B, 510G, and 510L represent symbol display areas of the reel 502B that may corresponding respectively to symbol display areas 511B, 511G, and 511L, which represent symbol display areas of reel 502G. Additionally, the symbol display areas 510C, 510H, and 510M of reel 502C may vertically align with the symbol display areas 511C, 511H, and 511M of reel 502H, and the indicator display area 512C of linking display area 502M. In such arrangement, in some implementations, the symbol display areas 510C, 510H, and 510M represent symbol display areas of the reel 502C that may correspond respectively to symbol display areas 511C, 511H, and 511M, which represent symbol display areas of reel 502H. Moreover, the symbol display areas 510D, 510I, and 510N of reel 502D may vertically align with the symbol display areas 511D, 511I, and 511N of reel 502I, and the indicator display area 512D of linking display area 502N. In such arrangement, in some implementations, the symbol display areas 510D, 510I, and 510N represent symbol display areas of the reel 502D that may correspond respectively to symbol display areas 511D, 511I, and 511N, which represent symbol display areas of reel 502I. Further, the symbol display areas 510E, 510J, and 510O of reel 502E may vertically align with the symbol display areas 511E, 511J, and 511O of reel 502J and the indicator display area 512E of linking display area 502O. In such arrangement, in some implementations, the symbol display areas 510E, 510J, and 510O represent symbol display areas of the reel 502E correspond respectively to symbol display areas 511E, 511J, and 511O, which represent symbol display areas of reel 502J.

The reels 502A-502E may display symbols in their respective symbol display areas 510A-510O that have been determined by the gaming system (such as previously described with regard to block 417 in FIG. 4A). In some implementations, the reels 502A-502E are associated with respective symbol sets (e.g., game symbols 314), where each symbol set includes a number of game symbols (e.g., a pool of game symbols). The symbol sets can include the same or different game symbols, and such different game symbols may be duplicated (e.g., weighted) within the symbol set so as to be selectable at different rates or frequencies. As previously described herein, the game symbols can include suitable symbol types such as graphic indicators, pay symbols, modifier symbols, special symbols, wild symbols, trigger symbols, or designated symbols.

In addition to the game reels 502A-502E, the game screen 500A can also include several information areas and buttons 505A-505I. These information areas and buttons 505A-505I are illustrated in a particular arrangement, but may be arranged in any suitable manner in different implementations. In some implementations, the game screen 500A may include more or fewer display areas and buttons 505A-505I than illustrated.

Information area 505A illustrates an example value of one credit (e.g., $1) for the game displayed in the game screen 500. Information areas 505B and 505C illustrate an example of the amount of the player's available credits. For example, the value displayed in information 505C (“500”) may represent the credit balance determined based on a monetary value received from a player via a value acceptor device (such as previously described with regard to blocks 401 and 403 of FIG. 4A). Information area 505D illustrates the amount of credits a player has won (such as previously described with regard to block 419 in FIG. 4B). For example, as illustrated in FIG. 5C, information area 505D shows “10” credits have been won. Notably, because FIG. 5A illustrates the start of a play of a game, the information area 505D shows zero credits have been won.

Button 505E illustrates a software button that the player can select to place a wager (e.g., a bet, such as previously described with regard to block 405 in FIG. 4A). It should be appreciated that the functionality of button 505E may also be replicated or replaced with a hardware button on the gaming system 100. Information area 505F illustrates an amount of the wager at information area 505E. For example, as illustrated in FIG. 5A, information area 505F indicates the player has selected to wager 1 credit.

Information area 505G illustrates a software button that the player can select to determine how many pay lines to wager on (such as previously described with regard to block 409 in FIG. 4A). It should be appreciated that the functionality of button 505G may also be replicated or replaced with a hardware button on the gaming system. Information area 505H illustrates a number of pay lines selected by the player using information area 505G. For example, as illustrated in FIG. 5A, information area 505G indicates the player selected to wager on 3 pay lines for the 1 credit indicated by information area 505F. Button 505I illustrates a software button that the player can select to obtain information about the game, change certain aspects of the game, obtain help, place an order, etc. It should be appreciated that the illustrated information areas and buttons 505A-505I are exemplary for understanding of the gaming system and that any suitable arrangement of information and buttons, including no displayed information or buttons, may be presented in various implementations.

To start a gaming session using the gaming system, a player provides the gaming system with a deposit of value, using one of the suitable mechanisms discussed above (such as previously described with regard to block 401 in FIG. 4A). The gaming system can validate the deposit of value received from the player. The gaming system can then issue credits (or gaming credits) to the player based on the received value (such as previously described with regard to block 403 in FIG. 4A). The credits enable the player to place wagers on the play of the game and initiate a play of a game (such as previously described with regard to blocks 405-411 in FIG. 4A). The gaming system may provide a visual indication of the player's credit balance to the player as discussed above in information area 505C.

To initiate the play of the game during the gaming session, the player can activate or press one or more appropriate buttons on the gaming system to deduct credits necessary to play the game and to identify the wager received from the player (such as previously described with regard to block 405 in FIG. 4A). The gaming system may deduct the credits (e.g., 1 credit) from the player's credit balance after the wager or at any suitable time (such as previously described with regard to block 407 in FIG. 4A). In some implementations, the gaming system may also update the player's credit meter (information area 505C) to reflect the player's available credit balance after deducting the credit (e.g., 497 credits). In some implementations, along with receiving the player's wager, the gaming system may receive pay line selections or other game functions the player wishes to activate in exchange for the wager (such as previously described with regard to block 409 in FIG. 4A). In some implementations, the gaming system automatically selects the pay lines for the player. The player may also actuate a game start button, a spin button, or a lever to initiate a play of a game (e.g., input device 115).

After initiating a game (e.g., at block 409 in FIG. 4A) and prior to displaying the symbols for such game in the symbol display areas 510A-510O, 511A-511O, and indicator display areas 512A-512E (e.g., at block 417 in FIG. 4A) the gaming system may cause the game screens 500A-500C to display the reels 502A-502J spinning, for example, to simulate the movement of mechanical reels. For example, as represented by the dashed lines in FIG. 5B, the gaming system may show a display of spinning reels for each of the reels 502A-502J. The spinning may appear to occur in a vertical top to bottom direction or in a vertical bottom to top direction (not shown), or in a combination of vertical directions (not shown). In some implementations, game screen 500C may show indicator display areas 512A-512E spinning in a direction with reels 502A-502J or may show indicator display areas 512A-512E representing a horizontal reel spinning in a horizontal direction that is perpendicular to the reels 502A-502J. It is understood that other displays can be used that do not simulate game reels of a slot machine. For example, the gaming system can display the game reels spinning in more than one direction, or the gaming system may not provide any display depicting the reels spinning. It is also understood that games other than a spinning reel slot machine may be provided using the game reels 502A-502J. For example, in some implementations, the gaming system may display symbols in the symbol display areas 510A-510O, 511A-511O, and indicator display areas 512A-512E in the reels 502A-502J and linking display areas 502K-502O as randomly changing or changing in some pattern. Also, while the symbol display areas 510A-510O and 511A-511O are illustrated with defined boxes, it should be appreciated that in some implementations, such boxes are not visible to the player. It should also be appreciated that in some implementations, the symbol display areas are other shapes or not defined shapes and may not be associated with the reels 502A-502J. Further, it should be also appreciated that the game shown in the game screens is merely representative and may have more or fewer game elements (e.g., reels, symbol display areas, symbols, etc.) that shown in the game screens.

As illustrated in FIG. 5C, the gaming system can randomly determine and display symbols for the game in symbol display areas 510A-510O, 511A-511O, and can randomly determine indicators for indicator display areas 512A-512E of the game reels 502A-502E, 502F-502J, and linking display areas 502K-502O, respectively (such as previously described regarding blocks 411-417 in FIG. 4A). The gaming system can display the symbols after the spinning of the game reels 502A-502E, 502F-502J, and indicator determinations for linking display areas 502K-502O in FIG. 5B has stopped. It is understood that the gaming system can start and stop spinning the reels 502A-E and 502F-502J at the same time or at different times.

FIG. 5C illustrates one example of the randomly-determined symbols that may be displayed by the symbol display areas 510A-510O, 511A-511O, and indicator display areas 512A-512E after the reels 502A-502E, 502F-502J, and linking display areas 502K-502O have stopped. In some implementations, the gaming system can evaluate the game symbols determined for the game reels 502A-502E of the game screen 500A for winning symbol combinations (such as previously described with regard to block 419 in FIG. 4A). In the present example, the gaming system may evaluate the symbols displayed in the game screen 500A and determine whether, based on a pay table, the symbol display areas 510A-510O of the reels 502A-502E include winning symbols or winning symbol combinations corresponding to one or more awards. The gaming system may update the information area 505D to reflect the award or amount of credits the player has won, if any, and may also update the player's gaming credit balance 505C in accordance with the calculated award amount for the play of the game (such as previously described with regard to block 421 in FIG. 4B). In some implementations, at least the active pay lines (e.g., wagered pay lines) are evaluated for winning symbol combinations. Any suitable quantity of pay lines may be used to evaluate winning symbol combinations. It should be appreciated that the displayed combinations of game symbols shown in FIG. 5C are merely for explanatory purposes and the gaming system may randomly generate any suitable combination of game symbols based on defined sets of game symbols respectively associated with the reels 502A-502E.

Additionally, the gaming system can trigger a multiple game screen interaction based upon the evaluation of the game symbols determined for the game reels 502A-502E of the game screen (such as previously described with regard to block 427 in FIG. 4B). In some implementations, the play of the game may end if the combination of game symbols displayed in FIG. 5C does not trigger the multiple game screen interaction (such as previously described with regard to block 427, “No” in FIG. 4B). In such case, the player may continue the gaming session (e.g., play another consecutive play of the game) by executing another play of the game (such as previously described with regard to block 405 in FIG. 4A). That is, the player may place another wager to continue a gaming session by starting a new play of the game. However, continued game play is dependent upon the quantity of credits remaining in the player's credit balance (e.g., as displayed in information area 505C). The player may also choose to cash out. In such an instance, the gaming system provides the player a value based on the player's credit balance using any of the value dispensing items discussed above (bills, coins, vouchers, etc.).

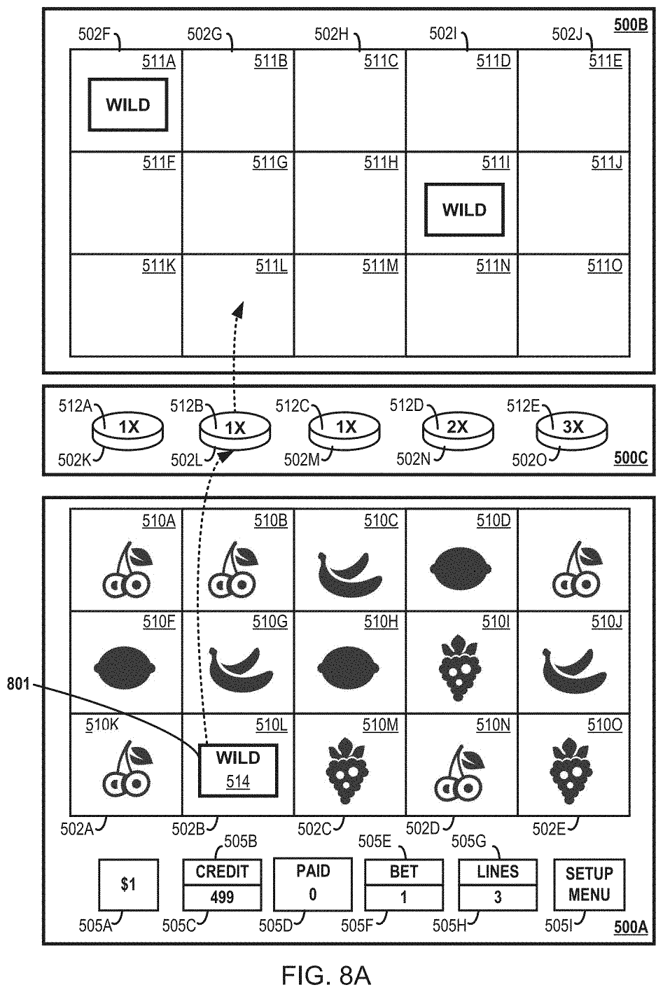

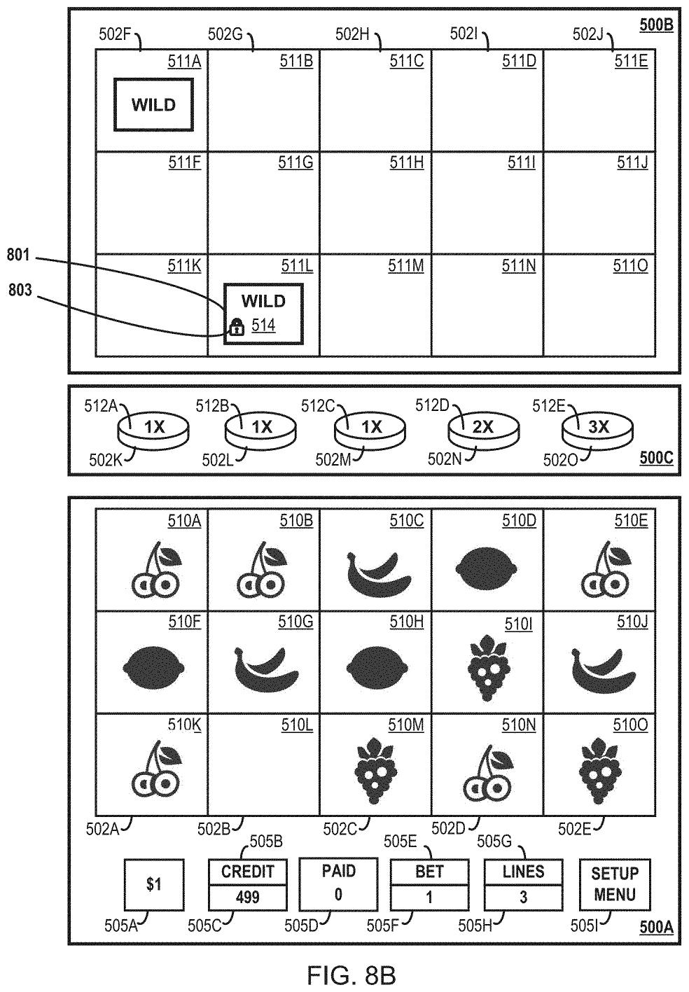

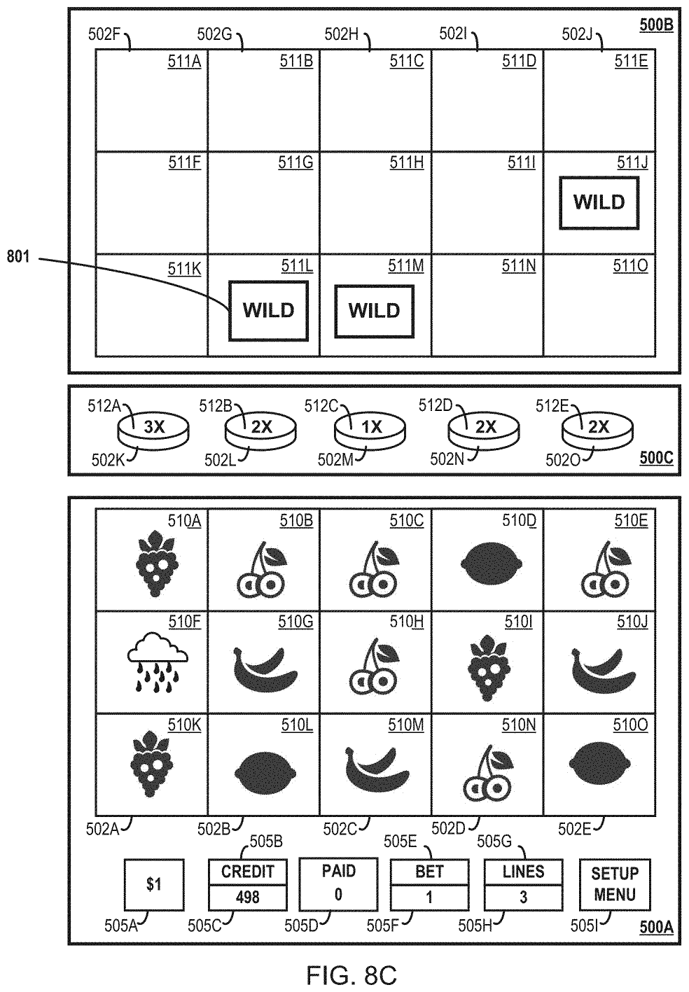

In some implementations, if the combination of game symbols displayed in FIG. 5C does not trigger the multiple game screen interaction, the gaming system may store one or more symbols displayed in symbol display areas 510A-510O by reels 502A-502E of the game screen 500A for use in a subsequent play of the game before ending the game. For example, as previously described with regard to FIG. 4C and described below regarding FIGS. 8A-8C, the gaming system may identify one or more predetermined symbols in the game screen 500A (e.g., WILD symbols that were not included in any winning combination and store such second symbols in symbol display areas of the game screen 500B, as will be described in greater detail hereinbelow.

On the other hand, if the gaming system evaluates the game symbols displayed in symbol display areas 510A-510O and, as illustrated in FIG. 5C, determines that the symbol display areas 510A-510O include one or more triggering symbols or combination of trigger symbols, such as trigger symbol 513 (e.g., as previously described regarding block 427 in FIG. 4B), then the gaming system can trigger the multiple game screen interaction. In some implementations, the gaming system may trigger the multiple game screen interaction when the triggering symbol (e.g., STORM symbol 513) is displayed in a symbol display area (e.g., one of areas 510A-510O) of the game screen 500A and a second symbol (e.g., WILD symbol 514) is displayed in second game screen 500B in a corresponding display area (e.g., one of areas 511A-511O). In some implementations, the gaming system may trigger the multiple game screen interaction when the symbol display areas 510A-510O display one or more of the trigger symbols 513 in predetermined symbol display areas 510A-510O or a predetermined pattern of the symbol display areas 510A-510O. For example, the gaming system may trigger the multiple game screen interaction when it determines that the trigger symbol 513 is displayed in symbol display area 510I of the game screen 500A. In some implementations, the gaming system may trigger the multiple game screen interaction when the symbol display area 510A-510O display a predetermined sequence or combination of trigger symbols 513. For example, the gaming system can trigger the multiple game screen interaction when sequence of three adjacent trigger symbols appear on a wagered pay line or a single game reel (e.g., in symbol display areas 510A, 510F, and 510K of reel 502A). It should be appreciated that the gaming system may trigger multiple screen interaction in any suitable manner.

In a non-limiting example, the trigger symbol 513 displayed in symbol display areas 510I may cause a corresponding second symbol 514 displayed in symbol display area 511I of second game screen 500B to pass through linking display area or portal 502N and be transposed or moved to symbol display area 510I the first game screen 500A (e.g., as previously described regarding blocks 429-439 in FIG. 4B). By comparison, in some implementations, the illustrated WILD symbols in symbol display areas 511A and 511L do not transpose from the second screen to the first game screen because, in accordance with the present example, the corresponding symbol display areas 510A and 510L of the first game screen do not include triggering symbols. It is understood that, in some implementations, the second symbol can move to any of the symbol display areas 510A-510O. For example, as illustrated in FIGS. 7A and 7B, the gaming system can randomly select one or more of the symbol display areas 510A-510O and transpose the second symbol into the selected one or more symbol display areas. In some implementations, one or more of the Wild symbols in second game screen may transpose based on the generation of the triggering symbol (e.g., STORM symbol 513).

As illustrated by FIG. 5D, in some implementations, the second symbol 514 may move to the game screen 500A through one of the linking display areas 510K-510O of a game screen 500C (e.g., as previously described regarding block 439 of FIG. 4B). In some implementations, game screen 500C and linking display areas 502K-502O may be viewed as a link (e.g., a portal) between the first game screen 500A and the second game screen 500B. In some implementations, a randomly determined and displayed indicator may be associated with one or more of the linking display areas 502K-502O and displayed in indicator display areas 512A-512E. The gaming system may, in some implementations, modify an amount of or an effect of the second symbols 514 being transposed or passing through the linking display areas 502K-502O. In some implementations, modifying the effect of second symbol 514 can include assigning a multiplier value corresponding to a value indicated by the indicator associated with the linking display areas 502K-502O. For example, if the linking display area 502N has an associated indicator of “2×” displayed in indicator display area 512D as illustrated in FIG. 5D, the transposed second symbol 514 may be modified to include a 2× multiplier to one or more winning symbol combinations in the first game screen 500A including the transposed second symbol 514. In some implementations, modifying the second symbol 514 includes increasing a quantity of the second symbol 514 after “passing through” the third game display screen 500C. For example, if the linking display area 502N displays an indicator 512D of “2” or “2×,” two copies of the second symbol 514 may emerge from third game display screen 500C and be displayed in the first game screen 500A. In some implementations, copies of the second symbol 514 may all displayed in the vertically-aligned reel of the first game screen corresponding to the reel of the game screen 500B that displayed the second symbol 514 and the linking display area of the game screen 500C, such as illustrated regarding FIGS. 6A and 6B. In other implementations, copies of the second symbol 514 are randomly displayed in symbol display areas of the first game screen 500A, such as illustrated in FIGS. 7A and 7B. For example, the copies of the second symbol 514 can fall from the linking display area of the third game screen 500C into randomly selected symbol display areas of the first game screen 500A. For example, in some implementations, when the gaming system triggers multiple game screen interactions, a symbol such as symbol 514 on second game screen 500B may activate and fall into or be drawn into third game screen 500C and disappear. Substantially simultaneously, multiple copies of the second symbol 514 may appear to rain down or otherwise fall into randomly selected symbol positions on the first game screen 500A.

As illustrated in FIG. 5E, after transposing the second symbol 514 from the second game screen 500B to the first game screen 500A via third game screen 500C, the gaming system may again evaluate the symbols displayed in the game screen 500A and based on the pay table, determine whether the symbol display areas 510A-510O of the 502A-502E include new winning combination(s) corresponding to an award (e.g., as previously described regarding block 443 of FIG. 4B). For example, FIG. 5E illustrates an example of a winning combination of game symbols LEMON-LEMON-LEMON-WILD ×2 in pay line 515, which may correspond to an award in a pay table for four lemons and, based on the multiplier from the indicator display area 512D in the third game screen 500C, the gaming system may multiple the award by four lemons award by 2 (e.g., an example four lemon award of 100×2, as shown in information area 505D) to generate an award of 200 credits. The gaming system may update the information area 505D to reflect the award or amount of credits the player has won, if any, and may also update the player's gaming credit balance 505C in accordance with the calculated award amount for the play of the game (such as previously described with regard to block 471 in FIG. 4D).

While the game screens 500A-500C illustrated in FIGS. 5A-5E describe an example in which the multiple game screen interaction is triggered based on trigger symbol 513, it is understood some implementations can activate the multiple game screen interaction in response to other events. In some implementations, the gaming system triggers the multiple game screen interaction based on determining that one or more symbols displayed in the first game screen 500A include one or more trigger symbols, a particular combination of trigger symbols, a particular arrangement of trigger symbols, or a particular sequence of trigger symbols. In some implementations, the gaming system triggers the multiple game screen interaction based on determining that one or more symbols displayed in the third game screen 500C include one or more trigger symbols, a particular combination of trigger symbols, a particular arrangement of trigger symbols, or a particular sequence of trigger symbols. In some implementations, the gaming system triggers the multiple game screen interaction based on determining that one or more symbols displayed in the third game screen 500C interacts with one or more symbols displayed in the first game screen 500A and/or the second game screen 500B, wherein the interaction causes the triggering of the multiple game screen interaction. In some implementations, the interaction may include the same symbols appearing in the same or different columns or reels, two or more predetermined symbols (e.g., the same or different symbols) that appear in the same or different columns or reels, a key symbol that appears with a lock symbol that interact to unlock the lock symbol, etc. In some other implementations, the gaming system can provide trigger symbols or trigger events using any one of the game screens 500A, 500B, or 500C. In some such implementations, the gaming system can randomly select one of the linking symbol display areas 502K-502O to trigger the multiple screen interaction and display an indication of the selection. For example, the gaming system can randomly select the linking symbol display area 502N to trigger the multiple game screen interaction, display a halo or other suitable indicator of the selection at the selected symbol display area 502N, and cause a corresponding second symbol 514 displayed in symbol display area 511I of the second game screen 500B to pass through the linking display area 502N and be transposed or moved to a random (or a predetermined) one of symbol display areas 510A-510O of the game screen 500A. In other such implementations, values or symbols determined for one or more indicator display areas 512A-512E of the linking symbol display areas 502K-502O or symbol display areas 511A-511O of game screen 500B can function in a same or similar manner to the trigger symbol 513 so as to trigger the multiple game screen interaction. Additionally, as described previously, in some other implementations, the gaming system activates the multiple game screen interaction based on an amount of a player's wager. In some implementations, the gaming system triggers the multiple game screen interaction based on an output from a bonus controller. In some implementations, the gaming system randomly triggers the multiple game screen interaction based on an output from the random number generator. In some implementations, the gaming system randomly triggers the multiple game screen interaction after occurrence of a threshold number of events since trigging a previous multiple game screen interaction.

FIGS. 6A and 6B show pictures of example the game screens 500A, 500B, and 500C displayed by the gaming system in accordance with some implementations. As noted previously, while game screen 500C is illustrated as a separate screen region from game screens 500A and 500B, it is understood that the elements and functionality of game screen 500C can be incorporated in game screen 500A, game screen 500B, or split between game screens 500A and 500B. More specifically, FIGS. 6A and 6B illustrate an example of a multiple game screen interaction triggered by a trigger symbol 513, such as previously described above with regard to FIG. 5C, in which multiple copies of one or more second symbols in game screen 500B are transposed into game screen 500A. In implementations, the gaming system can determine the quantity of copies based on the randomly determined value of the indicator display area 512D in linking display area 502N, which corresponds to, or “links,” reels 502D and 502I. In the present example, second symbol 514, such as the WILD symbol in symbol display area 511I may be transposed from the game screen 500B to the game screen 500A via the game screen 500C (e.g., via a symbol display area representing a portal) and, based upon the indicator “2×” in indicator display area 512D, two copies of WILD symbol 514 will emerge from third game screen 500C and be displayed on first game screen 500A. Accordingly, in some implementations, the symbols in the one or more symbol sets corresponding to the indicator display areas 512A-512E may include values ranging from 1 to N, where N is the quantity of rows of the game screen 500A. Hence, for an example gaming system having an M-row by N-column reel array of 3 rows×5 columns (e.g., a 3×5 array) as the first game screen 500A, the indicator values of the third game screen can range from 1-3 (e.g., the one or more third symbol sets may include the symbols 1×, 2× and 3× or more simply, 1, 2, and 3) or other suitable numbers. As such, in some implementations, the gaming system may transpose one to three copies of the second symbol 514 into 1, 2, or 3 of the symbol display areas of the corresponding reel of the game screen 500A and evaluate the symbol display areas 510A-510O for new winning symbol combinations or trigger events (e.g., as previously described with regard to block 443 in FIG. 4B). For example, depending on the value of the linking display area 512D, the gaming system may transpose copies of the second symbol 514 into some or all of symbol display areas 510D, 510I, and 510N. In some implementations, the second symbol 514 can populate the symbol display areas 510D, 510I, and 510N in a top-down fashion (e.g., first 510D, then 510I, then 510N). In some implementations, the second symbol 514 can populate the symbol display areas 510D, 510I, and 510N in a bottom-down fashion (e.g., first 510D, then 510I, then 510N). And, in some implementations, the second symbol 514 can populate the symbol display areas 510D, 510I, and 510N randomly.

FIGS. 7A and 7B show pictures of example game screens 500A, 500B, and 500C displayed by a gaming system in accordance with some implementations consistent with the present disclosure. As noted previously, while game screen 500C is illustrated as a separate screen region from game screens 500A and 500B, it is understood that the elements and functionality of game screen 500C can be incorporated in game screen 500A, game screen 500B, or split between game screens 500A and 500B. More specifically, FIGS. 7A and 7B illustrate another example of a multiple game screen interaction triggered by a trigger symbol 513, such as previously described above with regard to FIG. 5C, in which multiple copies of one or more second symbols in the second game screen 500B are transposed to the first game screen 500A via third game screen 500C. In implementations, the gaming system can determine the quantity of the copies based on the randomly determined values of the indicator display areas 512A-512E.

In the present example, FIG. 7A shows a winning symbol combination of LEMON-LEMON-LEMON in pay line 515A, which may pay an award of 10 credits, as shown in information area 505D and previously described with regard to FIG. 5C. Additionally, in response to the trigger symbol 513 in symbol display area 510I, the gaming system may trigger the multiple screen interaction feature and transpose the symbol from corresponding symbol display area 511I (e.g., WILD symbol 514) from the second game screen 500B to the first game screen 500A via the linking display area 512D. As illustrated in FIG. 7B, in some implementations, the linking display area 502N can transform the transposed second symbol 514 into multiple copies of the second symbol 514. That is, the indicator display area 512D displays a symbol indicating a value of 2× causing the second symbol 514 to multiply into two instances of the WILD symbol 514 as it is transposed to the first game screen 500A. In some implementations, the gaming system can display the two instances of the second symbol moving (e.g., falling) through linking display area 501N and into randomly-selected symbol display areas 510C and 510O of first game screen 500A.

In some implementations, the values indicated by the symbols in the symbol sets corresponding to the linking display areas 502K-502O of game screen 500C may include values ranging from 1 to X, where X is the quantity of symbol display areas of the game screen 500A. Hence, for an example gaming system having a first game screen 500A displaying 15 symbol positions (e.g., a 3×5 array), the values of the indicators of third game screen (e.g., the third symbol set) can range from 1-15. As such, the gaming system may create and move copies of the second symbol 514 between 1 and 15 of the symbol display areas 510A-510O in the game screen 500A. For example, depending on the value of the indicator display area 512D in linking display area 502N of the game screen 500C, the gaming system may transpose copies of the second symbol 514 into some or all of symbol display areas 510A-510O of first game screen 500A, and evaluate the symbol display areas 510A-510O for new winning symbol combinations or trigger events (e.g., as previously described with regard to block 443 in FIG. 4B). In some implementations, the second symbol 514 can populate the symbol display areas 510A-510O in a top-down fashion (e.g., first symbol display areas 510A-510E, then symbol display areas 510F-510J, and then symbol display areas 510K-510O). It is understood that other quantity ranges and population patterns can be used. In some implementations, copies of the second symbol 514 may populate the symbol display areas 510A-510A randomly.

With reference to FIG. 7B, the gaming system may reevaluate the first game screen 500A for new winning symbol combinations resulting from the new instances of the transposed second symbol 514. In the present example, the second symbol 514 displayed in symbol display area 510C forms a new winning symbol combination with the CHERRY symbols displayed in symbol display areas 510A and 510B (e.g., CHERRY-CHERRY-WILD). This new winning symbol combination indicated by pay line 515B, which may pay an award of 5 credits, as shown in information area 505D of FIG. 7B. Notably, in some implementations, the winning symbol combination of LEMON-LEMON-LEMON in pay line 515A of FIG. 7A is not a new winning symbol combination and, instead, the gaming machine previously determined an award for such combination. Therefore, in some implementations, the gaming system may not pay a second award for the combination of LEMON-LEMON-LEMON after the transposition of the second symbol 514. In some other implementations, the gaming system may pay awards for winning combinations without regard to previous evaluations.

FIGS. 8A, 8B, and 8C show examples the game screens 500A, 500B, and 500C displayed by a gaming system in accordance with some implementations. As noted previously, while game screen 500C is illustrated as a separate screen region from game screens 500A and 500B, it is understood that the elements and functionality of game screen 500C can be incorporated in game screen 500A, game screen 500B, or split between game screens 500A and 500B. More specifically, FIGS. 8A-8C illustrate an example of a multiple game screen interaction in which one or more multiple copies of one or more predetermined first symbols in the game screen 500A is transposed to the game screen 500B. As previously described above, the gaming system may store predetermined first symbols displayed in the game screen 500A in the game screen 500B in the event that the predetermined first symbol does not combine with other symbols in the game screen 500A in a winning symbol combination (e.g., as previously described regarding block 447 in FIG. 4C). For example, as illustrated in FIG. 8A, predetermined first symbol 801 in symbol display area 510L of the game screen 500A does not form a winning symbol combination with any of the other symbols of game screen 500A. As illustrated in FIG. 8B, for example, the game system may transpose or create a copy of the predetermined first symbol 801 to the game screen 500B and store it for use in subsequent games. In some implementations, the predetermined first symbol 801 moves to the game screen 500B through the game screen 500C in a same or similar manner to that previously described herein. In some implementations, the first symbol 801 may move from a symbol display area in the first game screen 500A to a corresponding symbol display area in the second game screen 500B via a corresponding symbol display area of the third game screen 500C (e.g., as previously described regarding block 459 of FIG. 4C). For example, the first symbol 801 may move from symbol display area 510L of the game screen 500A to symbol display area 511L of the game screen 500B via linking display area 502L of the game screen 500C. In other implementations, the gaming system can move or transpose multiple copies of the first symbol 801 to multiple randomly-selected symbol display areas 511A-511O in the game screen 500B based on the value of the corresponding display area 512B in the game screen 500C.

As illustrated in FIG. 8B, the gaming system can lock the first symbol 801 in symbol display position 511L of the game screen 500B after transposition. For example, in some implementations, a lock indicator 803 may be added to the first symbol 801 stored in symbol display area 511L to indicate that the first symbol 801 is locked and, therefore, will not be replaced in one or more next plays of the game. In the present example, as illustrated in FIG. 8C, a subsequent game has replaced the symbols displayed in the symbol display areas 510A-510O, 511A-511O, and indicator display areas 512A-512E of game screens 500A, 500B, and 500C respectively, except for the first symbol 801 that was locked in FIG. 8B. Notably, in FIG. 8C, the lock indicator 803 is absent indicating that the first symbol 801 is unlocked and that the gaming system will replace the first symbol 801 in a next play of the game.

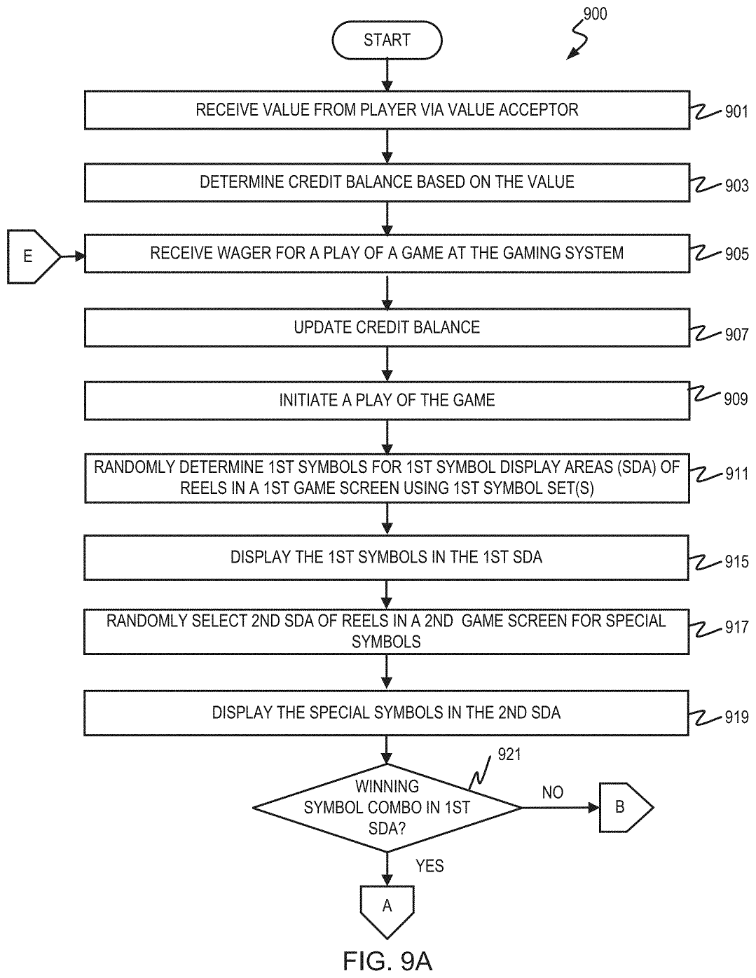

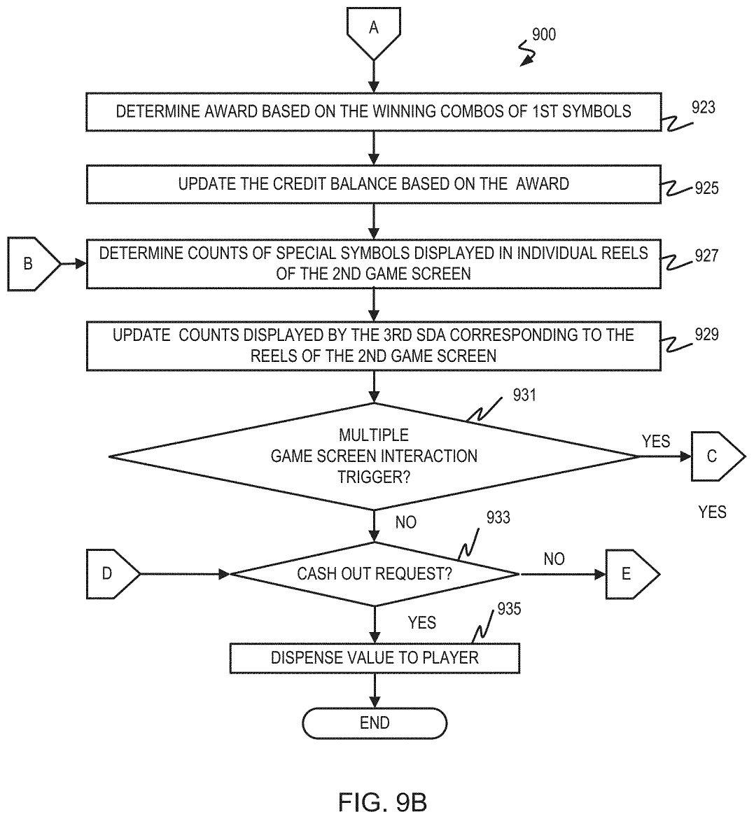

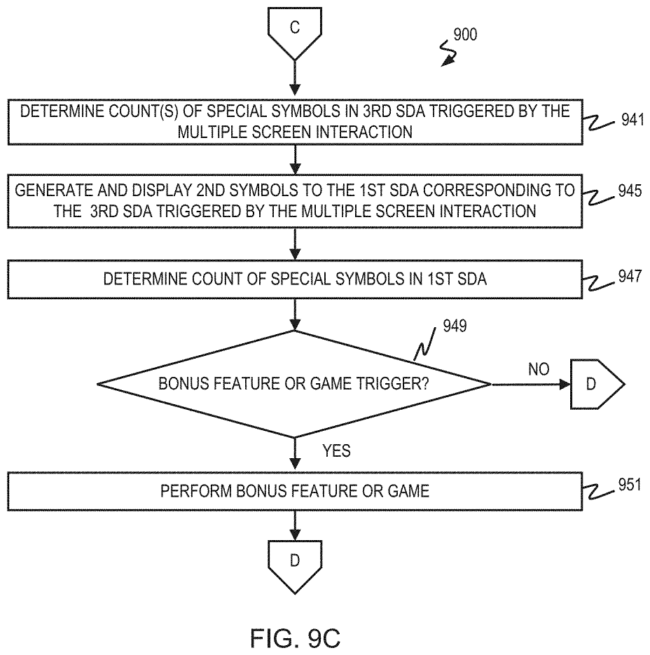

The flow diagrams in FIGS. 9A-9C illustrate functionality and operations of systems, devices, processes, and computer program products according to various additional implementations of the present disclosure. In some implementations, a play of a game begins when the gaming system receives a monetary value from a player (e.g., block 901). In other implementations, a play of the game begins when the gaming system receives a wager (e.g. block 905). In some implementations, a play of the game can start after block 931. The play of the game can end when the first part of the game is complete and a second part of the game is not triggered or otherwise initiated at block 931. In some implementations, the play of the game can also end when the gaming system receives a request to cash out (e.g., block 933, “Yes”). In some implementations, blocks 933 and 935 are not part of a play of a game. In alternative implementations, blocks 933 and 935 are part of a play of a game.

Turning to block 901 in FIG. 9A, in some implementations, the gaming system (e.g., gaming system 100) performing the operation, process, or method 900 receives a monetary value or other value via a value acceptor device (e.g., value acceptor 225). In block 903, the gaming system determines a credit balance based on the monetary value received in block 901. In block 905, the gaming system receives a wager for a play of a game from a player via an input device (e.g., input device 115) using, e.g., the credit balance determined at block 903, and the gaming system may update the credit balance as indicated at block 907. At block 909, the gaming system initiates a play of the game. The gaming system can perform blocks 901-909 in a same or similar manner to that previously described herein regarding FIG. 4A.

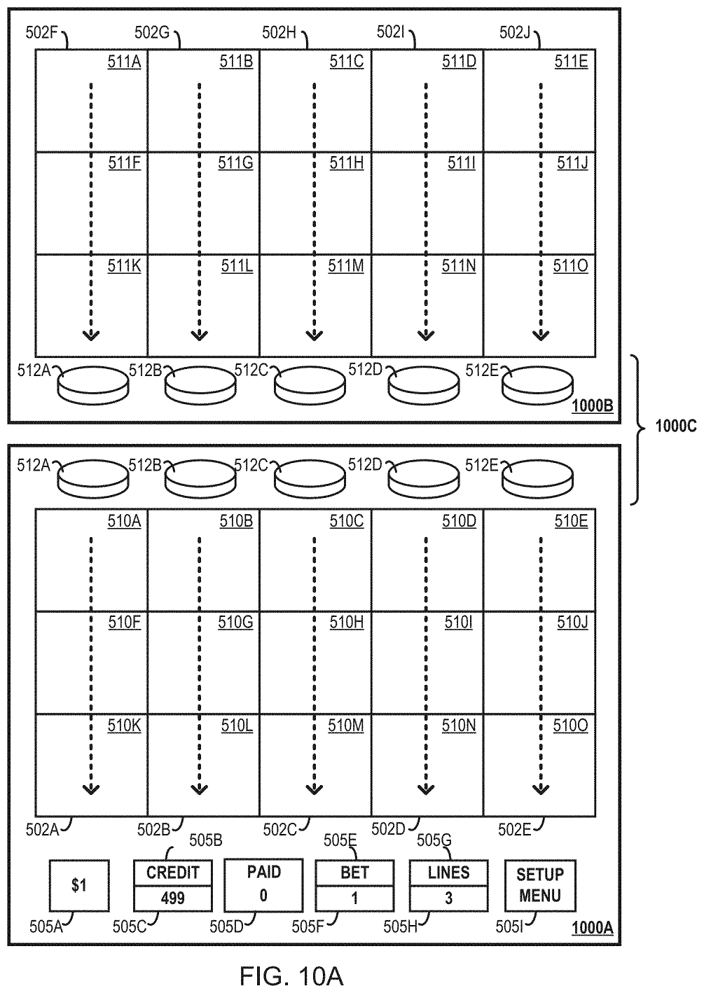

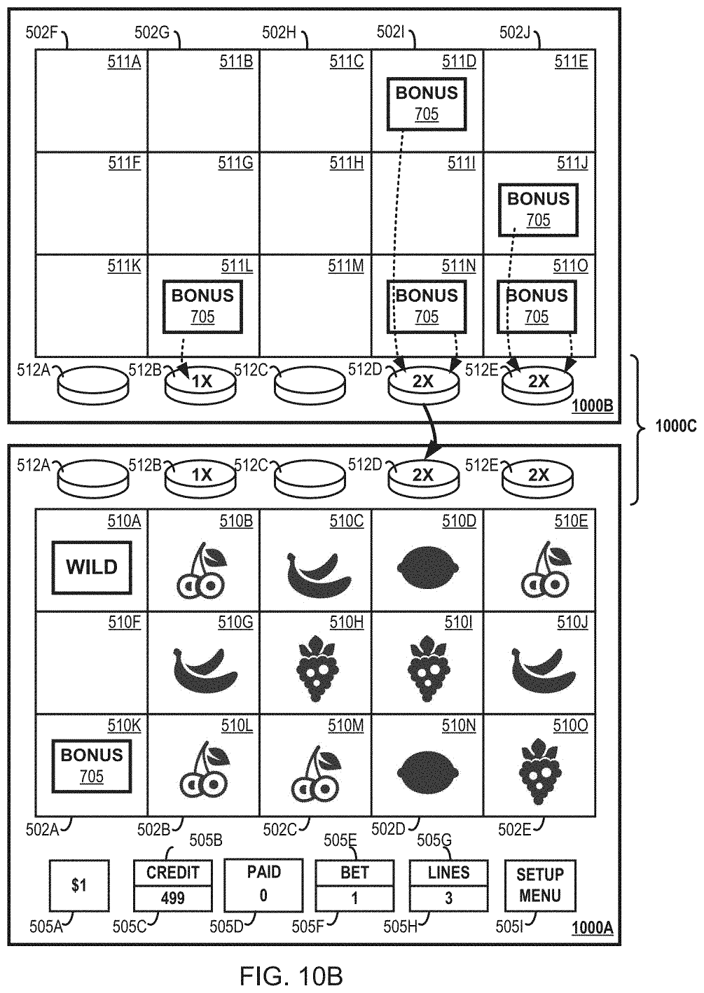

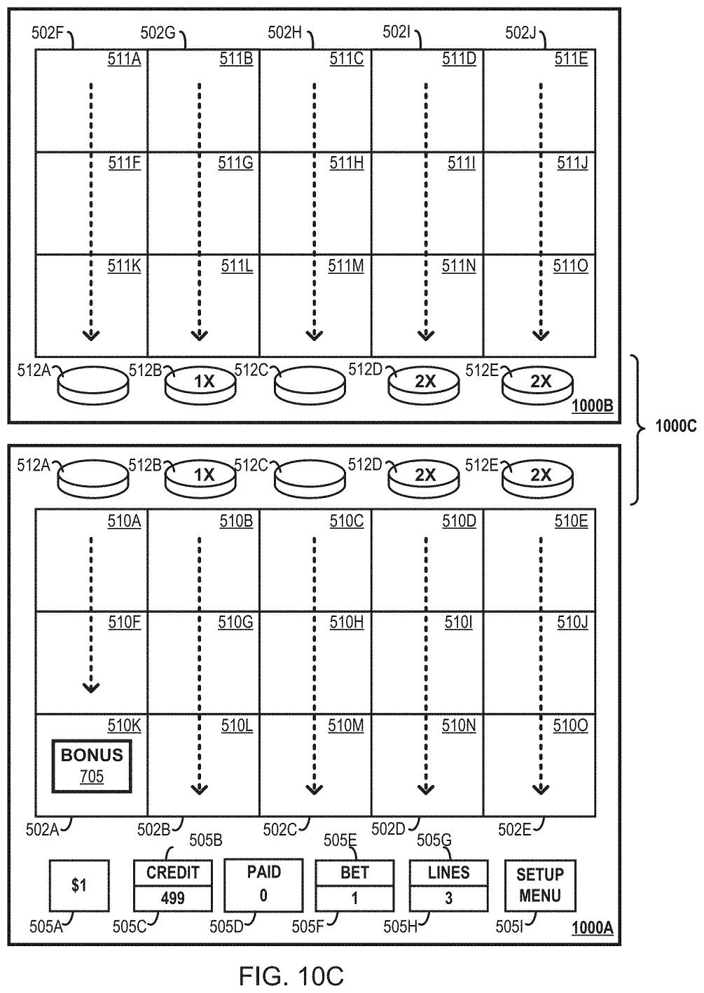

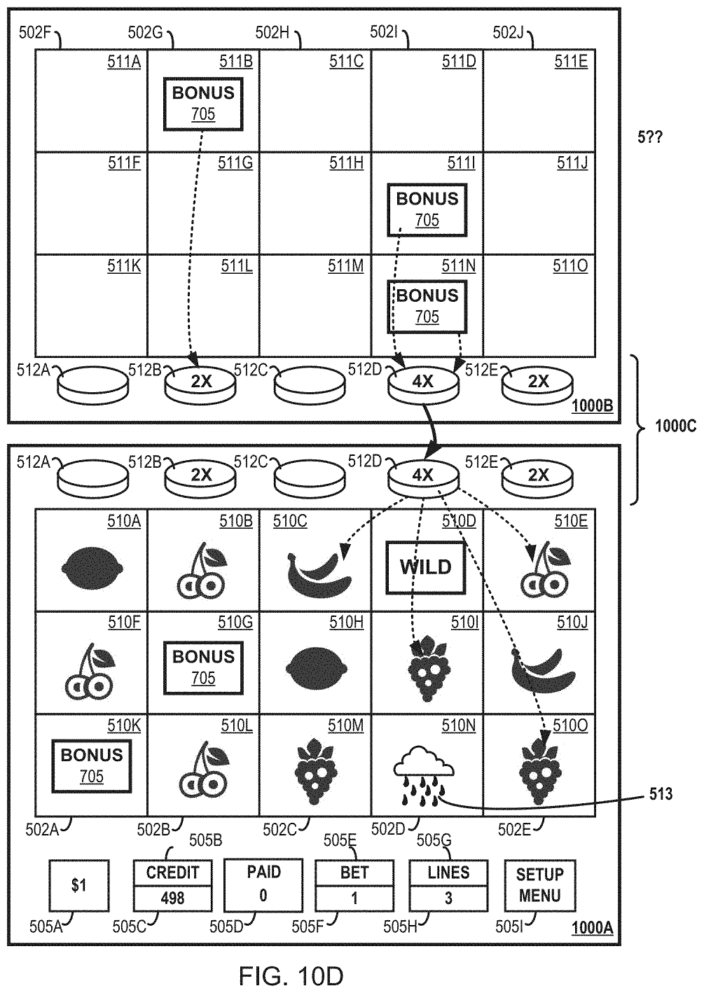

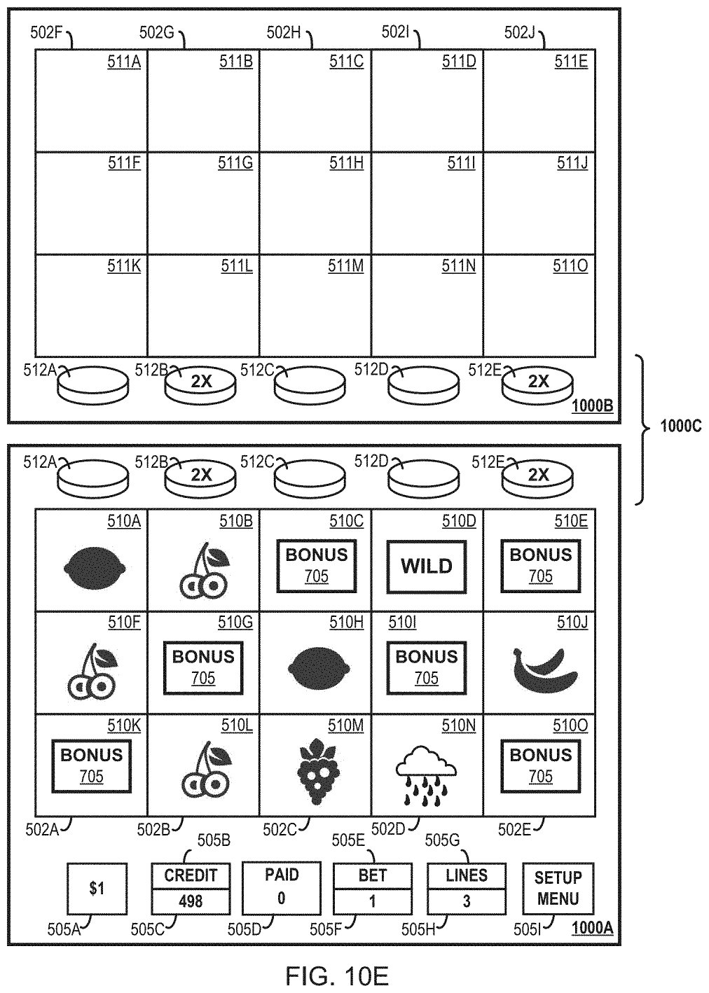

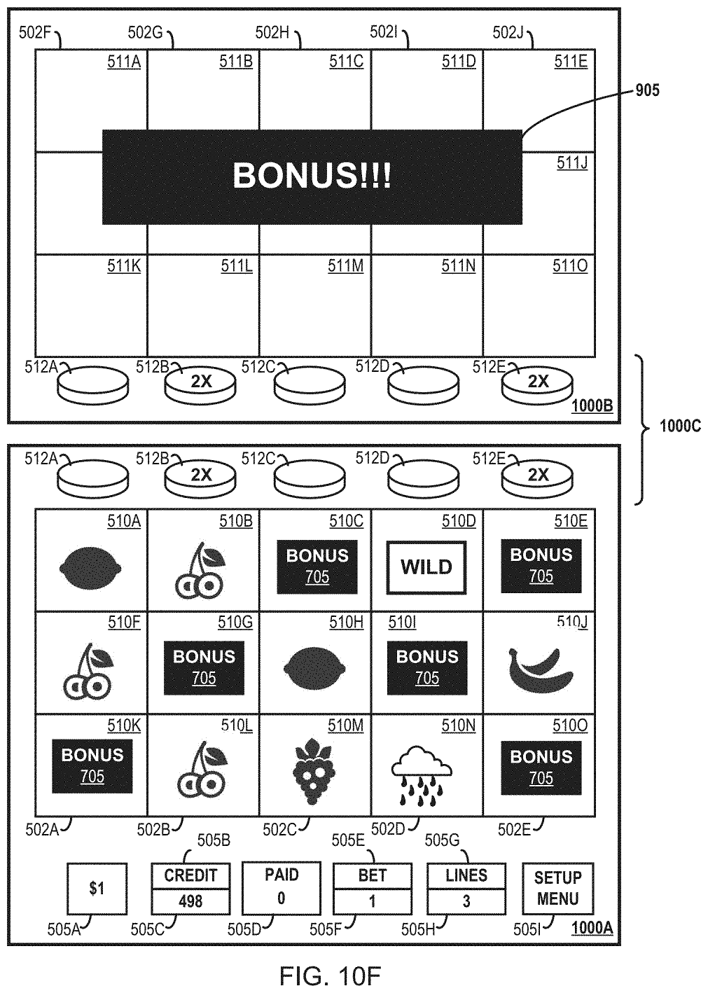

At block 911, the gaming system randomly determines, using a random number generator (e.g., random number generator 207), first symbols for symbol display areas (e.g., symbol display areas 510A-510O in FIG. 10A) a first game screen (e.g., first game screen 1000A in FIG. 10A) using one or more symbol sets corresponding to a first game screen. At block 915, the gaming system causes one or more display devices (e.g., display device 120, 130, 134) to display the first symbols determined for the first game screen. The gaming system can perform blocks 911 and 915 using symbol sets and symbols in a same or similar manner to that previously described herein regarding FIG. 4A.

At block 917, the gaming system randomly determines, using a random number generator (e.g., random number generator 207), second symbols for symbol display areas (e.g., symbol display areas 511A-511O) a second game screen (e.g., second game screen 1000B in FIG. 10A) using one or more symbol sets corresponding to a second game screen. In some implementations, the gaming system selects the second symbols from one or more symbol sets in a same or similar manner to that previously described herein regarding FIG. 4A. In some such implementations, the second symbol sets may include blank symbols and special symbols. For example, the second symbols can be one or more types of special symbols (e.g., WILD symbols, multiplier symbols, trigger symbols, scatter symbols, collection symbols). The gaming system may accumulate occurrences of unused special symbols over time for use when multiple game screen interaction feature is triggered. In some implementations, the occurrence of second symbols can be accumulated and stored in the linking display areas until a gaming session ends or until a multiple screen interaction feature is triggered. In some implementations, the accumulation special symbols are stored by incrementing a count value (also referred to herein, for brevity, as “counts”) in the linking display areas (e.g., counts display areas 512A-512E of third game screen 1000C in FIG. 10A), as detailed below. At block 919, the gaming system causes one or more display devices (e.g., display device 120, 130, 134) to display the special symbols determined for the second game screen. It is understood that, in some implementations, the gaming system performs blocks 917 and 919 depending on the wager received at block 905 (e.g., a maximum wager).

At block 921, the gaming system evaluates the first symbols displayed in the first game screen 1000A at block 915 to determine whether the first symbols randomly determined at block 911 include one or more winning symbols and/or winning symbol combinations in a same or similar manner to that previously described herein regarding FIG. 4A. At block 921, if the gaming system determines that the first symbols determined at block 911 and displayed in the first game screen at block 915 do not include a winning symbol or winning symbol combination (e.g., block 921 is “No”), then the method 900 may proceed to block 927 of FIG. 9B, as indicated by off-page connector “B,” which is detailed below. On the other hand, at block 921, if the gaming system determines that the first symbols determined for the first game screen at 911 include a winning symbol combination (e.g., block 921 is “Yes”), then the method 900 proceeds to block 923 of FIG. 9B, as indicated by off-page connector “A.” At block 923, the gaming system determines one or more awards based on the winning symbols and symbol combinations determined at block 921. At block 925, in some implementations, the gaming system can update the credit balance determined at block 907 based on the amount of the award or awards determined at block 921. The gaming system can perform blocks 921, 923, and 925 in a same or similar manner to that previously described herein regarding FIGS. 4A and 4B.

In some implementations, at block 927, the gaming system determines counts of the special symbols displayed in the symbol display areas of the second game screen. In some implementations in which the second game screen includes symbol display areas representing reels of a slot machine, the gaming system can determine the number of displayed special symbols, or the count of the special symbols on a per-reel basis. For example, an individual reel of the second game screen 1000B may include three symbol display areas. Two of the symbol display areas of the individual reel may include a special symbol. Accordingly, in such example, the gaming system would determine the count of the special symbols for the individual reel to be two (2).

In some implementations, at block 929, the gaming system can update the respective counts for reels of second game screen 1000B as determined at block 927 to counts displayed by respective linking display areas. For example, as described in greater detail below regarding FIGS. 10A-10F, when a linking display area (e.g., count display area 512D) of game screen 500C displays a count of “0” (e.g., after being reset at the start of a gaming session, after being reset after a multiple game screen interaction feature, or other suitable reset event) and a reel corresponding to the linking display area (e.g., reel 502D) displays, for example, 2 special symbols, the gaming system can update the count of the linking display area to 2 (e.g., 0+2). Further, for example, if the linking display area of game screen 1000C is associated with game reels of the first and second display areas indicates a count of “2” and a subsequent game results in the corresponding reel (e.g., reel 502D) displaying 2 additional special symbols, the gaming system can update the count of the linking display area to 4 (e.g., 2+2). In other words, in some implementations, the counts for each reel in corresponding count display areas of third game screen 1000C accumulate the occurrence of special symbols displayed on each reel over time.

At block 931, the gaming system determines whether a multiple game screen interaction has been triggered in a same or similar manner that previously described regarding FIG. 4B. If the gaming system determines that the multiple game screen interaction has not been triggered (e.g., block 931 is “No”), then the method 900 proceeds to block 933. At block 933, the gaming system may receive a request or signal to end game play or “cash out” via an input device (e.g., an input device 115) of the gaming system (e.g., which would end the gaming session). In such a situation, the gaming system may dispense a value to the player, through a dispenser (e.g., value dispenser 222) based on the player's gaming credit balance as illustrated in block 935 and the method 900 ends. The gaming system can perform blocks 933 and 935 in a same or similar manner to that previously described herein regarding FIG. 4D.

On the other hand, if at block 931 the gaming system determines that the multiple game screen feature has been triggered (e.g., block 931 is “Yes”), then the method 900 proceeds to block 941 of FIG. 9C, as indicated by off-page connector “C.” At block 941, the gaming system determines a count of the special symbols stored in the linking display areas that have been triggered by the multiple game screen interaction. In some implementations, the multiple game screen interaction may trigger one or more of the linking display areas in the third game screen. In some implementations, the one or more linking display areas can be randomly selected. In other implementations, one or more special symbols that trigger the multiple game screen interaction trigger corresponding linking display areas. For example, a trigger symbol displayed in a reel of the first game screen may trigger a corresponding linking display area vertically aligned with the reel. Further, in some implementations, the quantity of linking display areas triggered may trigger increases in proportion to a quantity or type of trigger determined in the first game screen. For example, a greater number of trigger symbols or a higher-value trigger may trigger a greater number of third symbol display areas.

Continuing, at block 945, during the multiple game screen interaction feature, the gaming system may generate and display a quantity of special symbols in the symbol display areas of the first game screen 1000A corresponding to the counts displayed by the triggered linking display areas. For example, if the trigger of the multiple game screen interaction triggers a single linking display area indicating a count of “4,” the gaming system transposes and displays four new special symbols in the first game screen 1000A. In some implementations, the special symbols are displayed in a first game screen reel that corresponds to the triggered linking display area. In some implementations, the special symbols are displayed in randomly-selected first symbol display areas of first game screen 1000A. Further, in some implementation, the gaming system randomly selects first symbol display areas for displaying the special symbols.

At block 947, in some implementations, the gaming system may determine a count of the special symbols displayed in the first symbol display areas, including the special symbols generated and displayed at block 945. At block 949, the gaming system can determine whether the count of the special symbols determined at block 947 triggers a bonus game or feature. If not (e.g., block 949 is “No”), the method 900 can proceed to block 933 via off-page connector “D,” which is described above. On the other hand, if the count of the special symbols determined at block 947 triggers a bonus game or feature (e.g., block 949 is “Yes”), the gaming system can perform the bonus game or feature. In some implementations, the bonus game or feature can be an opportunity for a player to win additional awards without placing an additional wager or ante. For example, the bonus game or feature can be a game, such as slot machine or spinning award wheel, displayed on a same or different game screen. In some implementations, the bonus game or feature can be a multi-round game involving collection symbols, storage symbols, or locking symbols. It should be appreciated that the gaming system may trigger any suitable bonus game or feature. In some implementations, after performing the bonus game or feature, the method can return to block 933 in FIG. 9B, as previously described herein.

FIGS. 9A-9C illustrate some implementations of a multiple game screen interaction that determines, accumulates, and stores counts of special symbols in the second symbol display areas, as described in blocks 927, 929, and 941. However, it is understood that some implementations of the multiple game screen interaction described in 9A-9C can be performed in a same or similar manner to that previously described with regard to FIGS. 4A-4C. That is, in some implementations, the gaming system may randomly determine and display the count values of the linking display areas, as previously described regarding blocks 415 and 417, instead of determining and displaying counts of special symbols in the second symbol display areas, as described in blocks 927, 929, and 941.

FIGS. 10A-10F show example images of a game screens displayed by a gaming system (e.g., gaming system 100) in accordance with aspects of the present disclosure. More specifically, FIGS. 10A-10F illustrate example screen shots of game screens that may be displayed by display devices (e.g., display devices 120, 130, and 134) in some implementations of the gaming system. In some implementations, the game screens may be displayed on the display devices of gaming system illustrated in FIG. 1. However, any other suitable display device may be used. More specifically, FIGS. 10A-10F show example images of a game screens 1000A, 1000B, and 1000C displayed by a gaming system (e.g., gaming system 100) in some implementations, which may be the same or similar to those previously described herein (e.g., game screens 500A, 500B, and 500C).

After initiating a game (e.g., at block 909 in FIG. 9A) and prior to displaying the symbols for such game in the symbol display areas 510A-510O and 511A-511O (e.g., at blocks 915 and 919 in FIG. 9A), the gaming system may cause the game screens 1000A, 1000B, and 1000C to display the game reels 502A-502J spinning, as previously detailed herein. As illustrated in FIG. 10B, the gaming system can randomly determine and display symbols for the game in symbol display areas 510A-510O and 511A-511O of the game reels 502A-502E and 502F-502J (e.g., as previously described herein regarding blocks 911-919 in FIG. 9A). FIG. 10B illustrates one example of the randomly-determined symbols that may be displayed by the symbol display areas 510A-510O and 511A-511O after the reels 502A-502E and 502F-502J spinning in FIG. 10A stop.

In some implementations, the gaming system can evaluate the game symbols determined for the game reels 502A-502E of the game screen 1000A for winning symbol combinations (such as previously described with regard to block 921 in FIG. 9A). Additionally, in some implementations, the gaming system can evaluate the game symbols determined for the game reels 502A-502E to identify special symbols, such as trigger symbols and special symbols. For example, in the present example, BONUS triggering symbols can be special symbols that, after being displayed in a game, can persist for one or more subsequent plays of the game of a player's gaming session. In some implementations, once the player obtains a special symbol, the special symbol may persist its respective symbol display the symbol storage area for additional plays of the game until the player ends the gaming session by, for example, cashing-out at block 933. In some implementations, a player must continue to wager at the predetermined minimum level for each play of the game to maintain the persistence of any special symbols in the symbol storage area for additional plays of the game.

The gaming system also evaluates the symbols determined for symbol display areas 511A-511O in the game screen 1000B. In some implementations, the evaluation includes determining special symbols displayed in the screen 1000B. For example, in the example illustrated in FIG. 10B, symbol display area 511L of reel 502G, symbol display areas 511D and 511N of reel 502I, and symbol display areas 511J and 511O of reel 50J display the special symbols, BONUS. In accordance with aspects of the present disclosure, the gaming system can determine a count of the special symbols displayed in the individual reels 502F-502J of the second game screen 1000B and store the counts in the corresponding count display areas 512A-512E of third game screen 1000C. It should be appreciated that count display areas 512A-512E of third game screen 1000C may also function as a link or portal for transposing symbols between the second game screen 1000B and the first game screen 1000A in a manner similar to that described above. Continuing with the example illustrated in FIG. 10B, the gaming system determines that reels 502G includes one special symbol, that reel 502I includes two special symbols, and that reel 502J includes two special symbols. Accordingly, for linking display area 512A, 512D, and 512E corresponding to reels 502G, 502I and 502J, the gaming system can display an accumulating count of the special symbols displayed in the second screen during the gaming session. That is, linking display area 512B, 512D, and 512E updates a count of 1, 2, and 2, respectively. And, as reels 502F and 502H did not display any special symbols, the gaming system does not update the count of corresponding linking display area 512A and 512C.

In some implementations, the play of the game may end if the combination of game symbols displayed in the first game screen 1000A does not trigger a multiple game screen interaction feature, such is the situation in FIG. 10B does not trigger a feature (such as previously described with regard to block 927 in FIG. 9B). The player may continue the gaming session (e.g., play another consecutive play of the game) by executing another play of the game (such as previously described with regard to block 905 in FIG. 9A). That is, the player may place another wager to continue a gaming session by starting a new play of the game as noted above. However, continued game play is dependent of the quantity of credits remaining in the player's credit balance (e.g., as displayed in information area 505C). The player may also choose to cash out. In such an instance, the gaming system provides the player a value based on the player's credit balance using any of the value items discussed above (bills, coins, vouchers, etc.).

On the other hand, if the gaming system evaluates the game symbols displayed in symbol display areas 510A-510O and, as illustrated in FIG. 10D, determines that the symbol display areas 510A-510O include one or more triggering symbols or combination of trigger symbols, such as trigger symbol 513 (e.g., as previously described regarding block 931 in FIG. 9B), then the gaming system may trigger the multiple game screen interaction in a same or similar manner to that previously described regarding FIGS. 5A-5E. For example, the trigger symbol 513 displayed in symbol display areas 510N may cause a quantity of special symbols indicated by the corresponding linking display area 512D to be displayed in game screen 1000A. For example, in the illustration shown in FIG. 10D, the symbol display areas 510D, 510I, and 510N in reel 502D correspond to linking display area 512D, which indicates a value of 4×. Based on the correspondence, the gaming machine can generate and display four additional copies of the BONUS symbol in the first game screen 1000A in same or similar manners to those previously described regarding FIGS. 5A-8C. For example, in some implementations, the BONUS symbols may fill the symbol display areas of the corresponding reels 502D from the bottommost symbol display 510N and up to symbol display are 502D, the BONUS symbols may randomly fill the symbol display areas 510D, 510I, and 510N in reel 502D, or the BONUS symbols may fill randomly fill the symbol display areas 510A-510O.

Additionally, the gaming system may determine whether the special symbol displayed in game screen 1000A in FIG. 10E, including those generated and displayed based on the multiple game screen interaction trigger, provide a trigger of a bonus game or feature (e.g., as previously descried with regard to block 949 in FIG. 9C). For example, as illustrated in FIG. 10E, the first game screen 1000A may include six BONUS symbols, which may be greater than or equal to a predetermined quantity of BONUS symbols (e.g., a threshold of 5) that triggers a bonus game or feature, as illustrated in FIG. 10F. More specifically, FIG. 10F indicates that a bonus game or feature has been triggered by the special symbols displayed in game screen 1000A. While not illustrated, it is understood that the bonus game or feature can be one of various bonus games or features which can be displayed on a same or different game screen than game screens 1000A, 1000B, or 1000C.

Based on the forgoing description, it should be appreciated that a gaming system and method with improvements to game outcomes by unlocking additional symbols creates new and very exciting ways for a player to obtain improved winnings with a potential to earn greater awards. Such a potential to earn greater awards creates a greatly improved sense of anticipation for players.

The present disclosure is not to be limited in terms of the particular implementations described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations of the invention have been described. Various modifications may be made without departing from the spirit and scope of the invention. For example, various forms of the flows shown above may be used, with steps re-ordered, added, or removed. Accordingly, other implementations are within the scope of the following claims.

We claim:

1. A system comprising:
one or more display devices, an input device, a value acceptor, a value dispenser, a random number generator, a memory device, and a processor, wherein the memory device stores program instructions that, when executed by the processor, cause the processor to:
establish a credit balance based at least in part on a monetary value received by the value acceptor;
receive, via the input device, a wager;
initiate a play of a game based on the wager;
determine, using the random number generator, a plurality of first symbols for a first plurality of symbol display areas;
determine, using the random number generator, a plurality of second symbols for a second plurality of symbol display areas;
display, using the one or more display devices, the plurality of first symbols in the first plurality of symbol display areas;
display, using the one or more display devices, the plurality of second symbols in the second plurality of symbol display areas;
transpose one or more second symbols of the plurality of second symbols from the second plurality of symbol display areas to the first plurality of symbol display areas;
determine that the plurality of first symbols and the one or more second symbols displayed in the first plurality of symbol display areas includes a winning symbol combination;
determine one or more awards corresponding to the winning symbol combination;
display, using the one or more display devices, the one or more awards, wherein the credit balance is increased by the one or more awards award; and
issue, using the value dispenser, a value based on the credit balance in response to a cash out request.

2. The system of claim 1, wherein transposing the second symbol comprises:
determine that a trigger event of a multiple game screen interaction has occurred; and
moving, based on the trigger event, the one or more second symbols from the second plurality of symbol display areas to the first plurality of symbol display areas.

3. The system of claim 2, wherein determining that the trigger event of the multiple game screen interaction has occurred comprises:
determine that the plurality of first symbols displayed in the first plurality of symbol display areas includes a predetermined trigger symbol.

4. The system of claim 2, wherein determining that the trigger event of the multiple game screen interaction has occurred comprises:
determine that the plurality of first symbols displayed in the first plurality of symbol display areas includes a predetermined trigger symbol displayed at one of the plurality of first symbol display areas corresponding to one of the second plurality of symbols display areas displaying one of the one or more second symbols.

5. The system of claim 1, wherein transposing the one or more second symbols comprises:
removing the one or more second symbols from the second plurality of symbol display areas; and
replacing one or more of the plurality of first symbols with the one or more second symbols.

6. The system of claim 1, wherein transposing the second symbol comprises:
removing the one or more second symbols from the second plurality of symbol display areas; and
modifying one or more of the plurality of first symbols based on respective values of the one or more second symbols.

7. The system of claim 1, wherein:
the program instructions further cause the system to display, using the one or more display devices, a plurality of third symbols in a third plurality of symbol display areas; and
the first plurality of symbol display areas comprise a first plurality of reels of a slot machine;
the second plurality of symbol display areas comprise a second plurality of reels of the slot machine; and
the third plurality of symbol display areas correspond, respectively, to the first plurality of reels and to the second plurality of reels.

8. The system of claim 7, wherein moving the second symbol comprises:
determine values indicated by one or more third symbols of the plurality of third symbols displayed by one or more third symbol display areas of the third plurality of symbol display areas corresponding to one or more of the second plurality of reels including the one or more second symbols; and
modify the one or more second symbols based on the respective values indicated by one or more third symbols.

9. The system of claim 1, wherein transposing one or more second symbols of the plurality of second symbols from the second plurality of symbol display areas to the first plurality of symbol display areas further comprises increases an amount of the one or more second symbols in the first plurality of symbol display areas.

10. A method comprising:
establishing, by a processor, a credit balance based at least in part on a monetary value received by the value acceptor;
receiving, by the processor via an input device, a wager;
initiating, by the processor, a play of a game based on the wager;
determining, by the processor using a random number generator, a plurality of first symbols for a first plurality of symbol display areas;
determining, by the processor using the random number generator, a plurality of second symbols for a second plurality of symbol display areas;
displaying, by the processor using one or more display devices, the plurality of first symbols in the first plurality of symbol display areas;
displaying, by the processor using the one or more display devices, the plurality of second symbols in the second plurality of symbol display areas;
transposing, by the processor, one or more second symbols of the plurality of second symbols from the second plurality of symbol display areas to the first plurality of symbol display areas;
determining, by the processor, that the plurality of first symbols and the one or more second symbols displayed in the first plurality of symbol display areas includes a winning symbol combination;
determining, by the processor, one or more awards corresponding to the winning symbol combination;
displaying, by the processor using the one or more display devices, the one or more awards, the credit balance being increased by the one or more awards award; and
issuing, by the processor using a value dispenser, a value based on the credit balance in response to a cash out request.

11. The method of claim 10, wherein transposing the second symbol comprises:
determine that a trigger event of a multiple game screen interaction has occurred; and
moving, based on the trigger event, the one or more second symbols from the second plurality of symbol display areas to the first plurality of symbol display areas.

12. The method of claim 11, wherein determining that the trigger event of the multiple game screen interaction has occurred comprises:
determine that the plurality of first symbols displayed in the first plurality of symbol display areas includes a predetermined trigger symbol.

13. The method of claim 11, wherein determining that the trigger event of the multiple game screen interaction has occurred comprises:
determine that the plurality of first symbols displayed in the first plurality of symbol display areas includes a predetermined trigger symbol displayed at one of the plurality of first symbol display areas corresponding to one of the second plurality of symbols display areas displaying one of the one or more second symbols.

14. The method of claim 10, wherein transposing the one or more second symbols comprises:
removing the one or more second symbols from the second plurality of symbol display areas; and
replacing one or more of the plurality of first symbols with the one or more second symbols.

15. The method of claim 10, wherein transposing the second symbol comprises:
removing the one or more second symbols from the second plurality of symbol display areas; and
modifying one or more of the plurality of first symbols based on respective values of the one or more second symbols.

16. The method of claim 10, wherein:
the method further comprises displaying a plurality of third symbols in a third plurality of symbol display areas; and
the first plurality of symbol display areas comprise a first plurality of reels of a slot machine;
the second plurality of symbol display areas comprise a second plurality of reels of the slot machine; and
the third plurality of symbol display areas correspond, respectively, to the first plurality of reels and to the second plurality of reels.

17. The method of claim 16, wherein moving the second symbol comprises:
determining values indicated by one or more third symbols of the plurality of third symbols displayed by one or more third symbol display areas of the third plurality of symbol display areas corresponding to one or more of the second plurality of reels including the one or more second symbols; and
modifying the one or more second symbols based on the respective values indicated by one or more third symbols.

18. The method of claim 10, wherein transposing one or more second symbols of the plurality of second symbols from the second plurality of symbol display areas to the first plurality of symbol display areas further comprises increases an amount of the one or more second symbols in the first plurality of symbol display areas.

19. A non-transitory computer-readable storage device having program instructions stored therein, the program instructions being executable by a processor to cause a system to:
establish a credit balance based at least in part on a monetary value received by the value acceptor;
receive, via an input device, a wager;
initiating, a play of a game based on the wager;
determine, using a random number generator, a plurality of first symbols for a first plurality of symbol display areas;
determine, using the random number generator, a plurality of second symbols for a second plurality of symbol display areas;
display, using one or more display devices, the plurality of first symbols in the first plurality of symbol display areas;
display, using the one or more display devices, the plurality of second symbols in the second plurality of symbol display areas;
transpose one or more second symbols of the plurality of second symbols from the second plurality of symbol display areas to the first plurality of symbol display areas;
determine that the plurality of first symbols and the one or more second symbols displayed in the first plurality of symbol display areas includes a winning symbol combination;
determine one or more awards corresponding to the winning symbol combination;
display, using the one or more display devices, the one or more awards, the credit balance being increased by the one or more awards award; and
issue, using a value dispenser, a value based on the credit balance in response to a cash out request.

20. The non-transitory computer-readable storage device of claim 19, wherein:
the first plurality of symbol display areas comprise a first plurality of reels of a slot machine;
the second plurality of symbol display areas comprise a second plurality of reels of the slot machine;
a third plurality of symbol display areas correspond, respectively, to the first plurality of reels and to the second plurality of reels; and
the program instructions further cause the processor to:
display a plurality of third symbols in the third plurality of symbol display areas; and
determine values indicated by one or more third symbols of the plurality of third symbols displayed by one or more third symbol display areas of the third plurality of symbol display areas corresponding to one or more of the second plurality of reels including the one or more second symbols; and
modify the one or more second symbols based on the respective values indicated by one or more third symbols.
